(19) United States
(12) Patent Application Publication
(10) Pub. No.: US 2015/0230203 A1
(43) Pub. Date: Aug. 13, 2015

(54) MOBILE STATION, ACCESS NODE, SERVING NODE AND VARIOUS METHODS FOR IMPLEMENTING AN ABBREVIATED PAGE RESPONSE PROCEDURE

(71) Applicant: TELEFONAKTIEBOLAGET L M ERICSSON (PUBL), Stockholm (SE)

(72) Inventors: John Walter Diachina, Garner, NC (US); Nicklas Johansson, Brokind (SE); Ravitej Ballakur, Bangalore (IN); Björn Hofström, Linkoping (SE)

(21) Appl. No.: 14/606,712

(22) Filed: Jan. 27, 2015

Related U.S. Application Data
(60) Provisional application No. 61/937,274, filed on Feb. 7, 2014.

(51) Int. Cl. H04W 68/02

(52) U.S. Cl. CPC H04W 68/02

(57) ABSTRACT

A mobile station, an access node (e.g., BSS), a serving node (e.g., SGSN) and various methods are described herein for implementing an abbreviated page response (APR) procedure. The APR procedure improves a paging-page response scenario wherein the MS after receiving a paging message from the access node sends a page response to the access node using a single uplink radio block instead of establishing an uplink Temporary Block Flow (TBF) in order to send the page response. The APR procedure effectively improves the radio resource utilization efficiency between the mobile station and access node which is desirable in the wireless telecommunications field.

### CLAIM OF PRIORITY

This application claims the benefit of priority to U.S. Provisional Application No. 61/937,274, filed on Feb. 7, 2014. The entire contents of this application are hereby incorporated herein by reference for all purposes.

### TECHNICAL FIELD

The present disclosure relates to a mobile station (MS), an access node (e.g., BSS), a serving node (e.g., SGSN) and various methods for implementing an abbreviated page response (APR) procedure. The APR procedure improves a paging-page response scenario wherein the MS after receiving a paging message from the access node sends a page response to the access node using a single uplink radio block instead of establishing an uplink Temporary Block Flow (TBF) in order to send the page response.

### BACKGROUND

The following abbreviations are herewith defined, at least some of which are referred to within the following description of the prior art and the present invention.
AGCH Access Grant Channel
APR Abbreviate Page Response
ASIC Application-Specific Integrated Circuit
BSS Base Station Subsystem
CCCH Common Control Channel
CES/P Combined EGPRS Supplementary/Polling
DL Downlink
DRX Discontinuous Reception
EDGE Enhanced Data rates for GSM Evolution
EPROM Erasable Programmable Read Only Memory
EEPROM Electrically Erasable Programmable Read-Only Memory
EGPRS Enhanced General Packet Radio Service
EMDA GERAN Study on Mobile Data Applications
ES/P EGPRS Supplementary/Polling
FPGA Field-Programmable Gate Array
GERAN GSM EDGE Radio Access Network
GMM GPRS Mobility Management
GPRS General Packet Radio Service
GSM Global System for Mobile Communications
IA Immediate Assignment
IE Information Element
IP Internet Protocol
IPA Immediate Packet Assignment
LLC Logical Link Control
MS Mobile Station
MTC Machine Type Communications
PACCH Packet Associated Control Channel
PCH Paging Channel
PDAN Packet Downlink Ack/Nack
PDCH Packet Data Channel
PDTCH Packet Data Traffic Channel
PDU Protocol Data Unit
PUAN Packet Uplink Ack/Nack
RAM Random Access Memory
RACH Random Access Channel
RLC Radio Link Control
ROM Read Only Memory
SGSN Serving GPRS Support Node
TBF Temporary Block Flow
TCP Transmission Control Protocol
TDMA Time Division Multiple Access
TFI Temporary Flow Identity
TLLI Temporary Logical Link Identity
UDP User Datagram Protocol
UL Uplink
USF Uplink State Flag

In the wireless telecommunications field, it is desirable to improve the radio resource utilization efficiency between a mobile station and a network (e.g., BSS). Various ways that can be used to improve the radio resource utilization efficiency between the mobile station and the network (e.g., BSS) are the subject of the present disclosure.

### SUMMARY

A mobile station, an access node (e.g., BSS), a service node (e.g., SGSN), and various methods which improve the radio resource utilization efficiency are described in the independent claims. Advantageous embodiments of the mobile station, the access node (e.g., BSS), the serving node (e.g., SGSN), and the various methods are further described in the dependent claims.

In one aspect, the present disclosure provides a mobile station configured to implement an APR procedure with an access node (e.g., BSS). The mobile station comprises a processor and at least one memory that stores processor-executable instructions, wherein the processor interfaces with the at least one memory to execute the processor-executable instructions, whereby the mobile station is operable to perform a first receive operation, a first send operation, a second receive operation, and a second send operation. In the first receive operation, the mobile station receives a paging message from the access node. In the first send operation, the mobile station sends an access request to the access node in response to receiving the paging message. In the second receive operation, the mobile station receives an assignment message from the access node assigning a single uplink radio block. In the second send operation, the mobile station sends a page response using the single uplink radio block to the access node. The mobile station by implementing the APR procedure which comprises the first receive operation, the first send operation, the second receive operation, and the second send operation effectively improves the radio resource utilization efficiency between the mobile station and access node (e.g., BSS).

In another aspect, the present disclosure provides a method in mobile station for implementing an APR procedure with an access node (e.g., BSS). The method comprises a first receiving operation, a first sending operation, a second receiving operation, and a second sending operation. In the first receiving operation, the mobile station receives a paging message from the access node. In the first sending operation, the mobile station sends an access request to the access node in response to receiving the paging message. In the second receiving operation, the mobile station receives an assignment message from the access node assigning a single uplink radio block. In the second sending operation, the mobile station sends a page response using the single uplink radio block to the access node. The method in the mobile station for implementing the APR procedure which comprises the first receiving operation, the first sending operation, the second receiving operation, and the second sending operation effectively improves the radio resource utilization efficiency between the mobile station and access node (e.g., BSS).

In yet another aspect, the present disclosure provides an access node (e.g., BSS) configured to implement an APR procedure with a mobile station and a serving node (e.g., SGSN). The access node comprises a processor and at least one memory that stores processor-executable instructions, wherein the processor interfaces with the at least one memory to execute the processor-executable instructions, whereby the access node is operable to perform a first receive operation, a first send operation, a second receive operation, a second send operation, and a third receive operation. In the first receive operation, the access node receives a paging message from the serving node. In the first send operation, the access node sends the paging message to the mobile station. In the second receive operation, the access node receives an access request from the mobile station in response to sending the paging message. In the second send operation, the access node sends an assignment message to the mobile station in response to receiving the access request, where the assignment message indicates a single uplink radio block. In the third receive operation, the access node receives a page response on the single uplink radio block from the mobile station. The access node (e.g., BSS) by implementing the APR procedure which comprises the first receive operation, the first send operation, the second receive operation, the second send operation, and the third receive operation effectively improves the radio resource utilization efficiency between the mobile station and access node (e.g., BSS).

In still yet another aspect, the present disclosure provides a method in an access node (e.g., BSS) for implementing an APR procedure with a mobile station and a serving node (e.g., SGSN). The method comprises a first receiving operation, a first sending operation, a second receiving operation, a second sending operation, and a third receiving operation. In the first receiving operation, the access node receives a paging message from the serving node. In the first sending operation, the access node sends the paging message to the mobile station. In the second receiving operation, the access node receives an access request from the mobile station in response to sending the paging message. In the second sending operation, the access node sends an assignment message to the mobile station in response to receiving the access request, where the assignment message indicates a single uplink radio block. In the third receiving operation, the access node receives a page response on the single uplink radio block from the mobile station. The method in the access node (e.g., BSS) for implementing the APR procedure which comprises the first receiving operation, the first sending operation, the second receiving operation, the second sending operation, and the third receiving operation effectively improves the radio resource utilization efficiency between the mobile station and access node (e.g., BSS).

In yet another aspect, the present disclosure provides a serving node (e.g., SGSN) configured to implement an APR procedure with a mobile station and an access node (e.g., BSS). The serving node comprises a processor and at least one memory that stores processor-executable instructions, wherein the processor interfaces with the at least one memory to execute the processor-executable instructions, whereby the serving node is operable to perform a send operation, a first receive operation and a second receive operation. In the send operation, the serving node sends a paging message to the access node, where the paging message comprises trigger information which indicates to the MS that uplink payload is to be sent to the serving node. In the first receive operation, the serving node receives from the access node a page response in response to the paging message. In the second receive operation, the serving node receives from the access node the uplink payload provided by the MS in response to the trigger information provided in the paging message. The serving node (e.g., SGSN) by implementing the APR procedure which comprises the send operation and the receive operation effectively improves the radio resource utilization efficiency between the mobile station and access node (e.g., BSS).

In still yet another aspect, the present disclosure provides a method in a serving node (e.g., SGSN) for implementing an APR procedure with a mobile station and an access node (e.g., BSS). The method comprises a sending operation, a first receiving operation and a second receiving operation. In the sending operation, the serving node sends a paging message to the access node, where the paging message comprises trigger information which indicates to the MS that uplink payload is to be sent to the serving node. In the first receiving operation, the serving node receives from the access node a page response in response to the paging message. In the second receiving operation, the serving node receives from the access node the uplink payload provided by the MS in response to the trigger information provided in the paging message. The method in the serving node (e.g., SGSN) for implementing the APR procedure which comprises the sending operation and the receiving operation effectively improves the radio resource utilization efficiency between the mobile station and access node (e.g., BSS).

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings:

FIG. 1 (PRIOR ART) is a diagram of a legacy signaling procedure associated with a UDP/IP scenario where the delivery of downlink payload to a mobile station does not trigger a mobile station response;

FIG. 2A is a signaling diagram of an APR procedure associated with a non-triggering scenario in which the delivery of downlink UDP/IP packet payload to a mobile station does not trigger a mobile station response in accordance with a first embodiment of the present disclosure;

FIG. 2B is a flowchart of a method in the mobile station for implementing the APR procedure in accordance with the first embodiment of the present disclosure;

FIG. 2C is a flowchart of a method in the access node (e.g., BSS) for implementing the APR procedure in accordance with the first embodiment of the present disclosure;

FIG. 3 (PRIOR ART) is a diagram of a legacy signaling procedure (CASE #1) associated with a TCP/IP scenario where the delivery of downlink payload to a mobile station does trigger a mobile station response;

FIG. 4 (PRIOR ART) is a diagram of another legacy signaling procedure (CASE #2) associated with a TCP/IP scenario where the delivery of downlink payload to a mobile station does trigger a mobile station response;

FIG. 5A is a signaling diagram of the APR procedure associated with a triggering scenario where the delivery of downlink TCP/IP packet payload to a mobile station does trigger a mobile station response in accordance with a second embodiment of the present disclosure;

FIG. 5B is a flowchart of a method in the mobile station for implementing the APR procedure in accordance with the second embodiment of the present disclosure;

FIG. 5C is a flowchart of a method in the access node (e.g., BSS) for implementing the APR procedure in accordance with the second embodiment of the present disclosure;

FIG. 6 is a diagram illustrating timing associated with the legacy procedures of FIGS. 1 and 3-4 (PRIOR ART) and the APR procedure of FIGS. 2A-2C and 5A-5C as related to the use of UL TBF resources;

FIG. 7A is a signaling diagram of the APR procedure associated with a triggering scenario where the delivery of paging message payload triggers a mobile station response in accordance with a third embodiment of the present disclosure;

FIG. 7B is a flowchart of a method in the mobile station for implementing the APR procedure in accordance with the third embodiment of the present disclosure;

FIG. 7C is a flowchart of a method in the access node (e.g., BSS) for implementing the APR procedure in accordance with the third embodiment of the present disclosure;

FIG. 7D is a flowchart of a method in the serving node (e.g., SGSN) for implementing the APR procedure in accordance with the third embodiment of the present disclosure; and

FIG. 8 is a schematic view of the mobile station, access node (e.g., BSS), and serving node (e.g., SGSN) which are configured to implement the APR procedure and various methods in accordance with different embodiments of the present disclosure.

### DETAILED DESCRIPTION

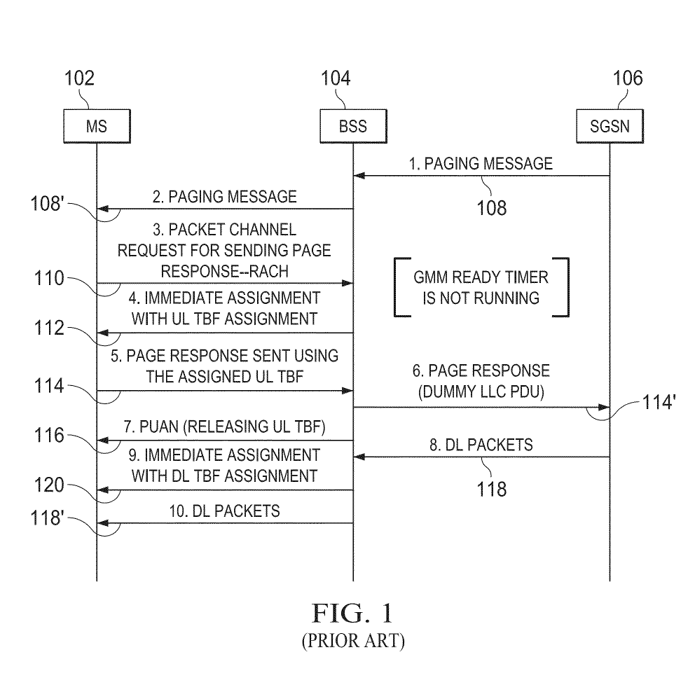

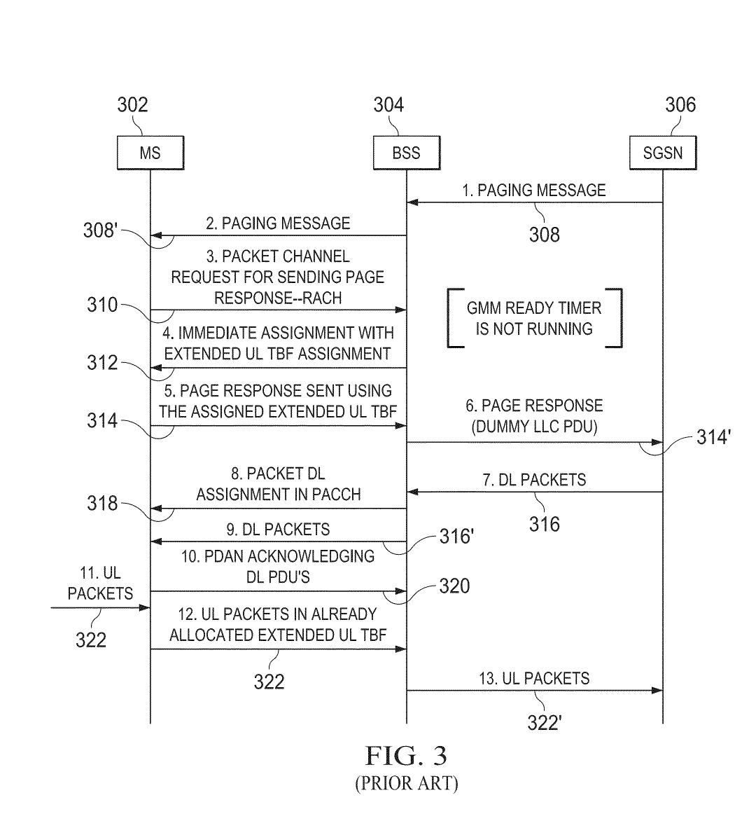

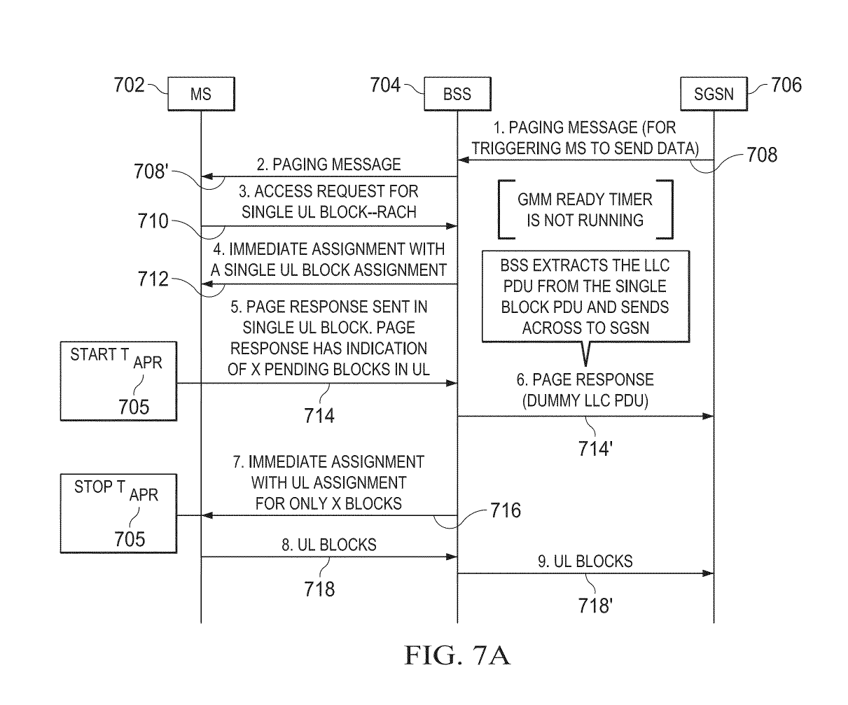

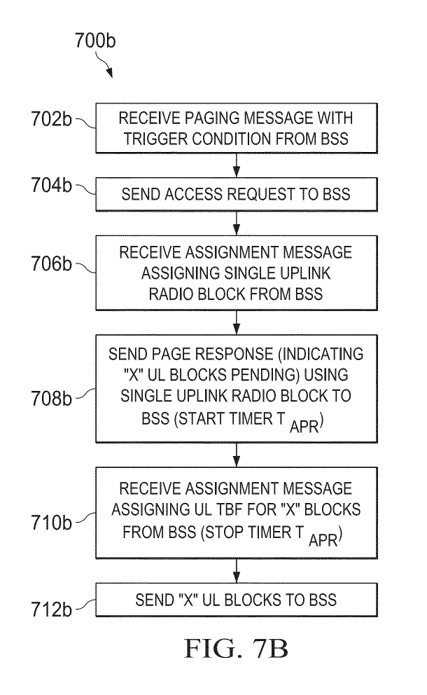

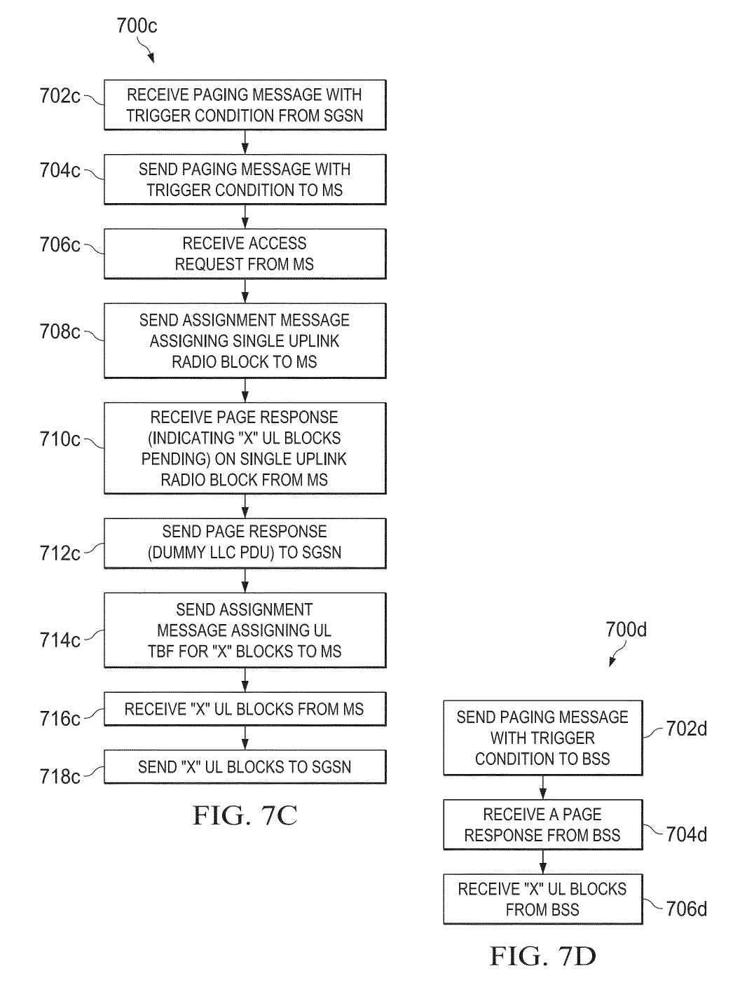

To describe the technical features of the present disclosure, a detailed discussion is provided first to explain the main features of an inventive Abbreviated Page Response (APR) procedure which effectively improves a paging-page response scenario wherein a MS after receiving a paging message from the access node (e.g., BSS) sends a page response to the access node (e.g. BSS) using a single uplink radio block instead of establishing an uplink TBF in order to send the page response. Then, a detailed discussion is provided to explain the main features of several different embodiments of the present disclosure wherein the APR procedure is implemented in the following scenarios: (1) the management of downlink payload delivery utilizing UDP/IP which does not trigger the MS to deliver uplink payload—see FIGS. 1, 2A-2C and 6; (2) the management of downlink payload delivery utilizing TCP/IP which triggers the MS to deliver uplink payload—see FIGS. 3, 4, 5A-5C and 6; and (3) the management of paging message delivery which triggers the MS to deliver uplink payload—see FIGS. 7A-7D. Although the APR procedure is described herein based on a wireless telecommunication system configured in accordance with the GERAN standards it should be appreciated that the APR procedure may be implemented in any wireless telecommunication system that has a paging-page response scenario which entails the assignment of and use of uplink radio resources.

The APR procedure improves the radio resource utilization efficiency by implementing a GERAN paging-page response scenario wherein the MS after receiving a paging message from the BSS sends a page response to the BSS using a single uplink radio block instead of establishing and using an uplink TBF. This new APR procedure reduces the amount of PACCH signaling performed within the paging—page response mechanism which is why it is referred to herein as the APR procedure. The APR procedure has the following technical features all of which do not apply to each embodiment described herein:

The MS may support the APR procedure due to the nature of the applications supported therein (e.g., a low cost MS with limited capabilities such as a smart meter) where it is in the interest of the operators to maximize the use of the APR procedure because of the radio resource utilization benefits it represents as discussed in detail below.

Paging Messages sent on the CCCH to a MS indicate when the APR procedure is supported in a serving cell (e.g., by using a Rel-13 extension to the P1/P2/P3 Rest Octets IE) thereby indicating that a MS which is also capable of implementing the APR procedure may indicate the same by using a new EGPRS Packet Channel Request code point indicating APR (see the “Abbreviated Page Response” code point in TABLE #1) when attempting a system access for the purpose of sending a page response.

The BSS responds to the reception of an access request which has the APR indicator by sending the MS an Immediate Assignment message allocating it a single uplink radio block which the MS uses to send the page response (i.e. an uplink TBF is not established).

The MS uniquely identifies itself (e.g., by including a TLLI) when sending the single uplink radio block containing the page response. The BSS relays the page response to a SGSN and when the BSS receives the corresponding downlink payload from the SGSN then the BSS sends the MS an Immediate Assignment message which assigns the MS a downlink TBF and then the BSS delivers the downlink payload to the MS (see FIGS. 1-6).

### First Embodiment: Using the APR Procedure for Delivering Downlink Payload (UDP/IP Scenario)

Referring to FIG. 1 (PRIOR ART), there is a diagram of a legacy signaling procedure associated with a UDP/IP scenario where the delivery of downlink payload to a MS does not trigger a MS response. In this exemplary diagram, the three main components namely a MS 102, an access node 104 (e.g., BSS 104), and a serving node 106 (e.g. SGSN 106) are shown interacting with one another per the legacy procedure to deliver the downlink payload to the MS 102 as follows:

1. The SGSN 106 sends a paging message 108 to the BSS 104.

2. The BSS 104 sends the paging message 108′ to the MS 102. The BSS 104 translates the paging message 108 received from the SGSN 106 on the Gb interface into the paging message 108′ which has a format appropriate for sending over the radio interface to the MS 102.

3. The MS 102 sends a packet channel request 110 (access request 110) to the BSS 104.

4. BSS 104 sends an Immediate Assignment message 112 with an UL TBF assignment to the MS 102.

5. The MS 102 sends a page response 114 using the assigned UL TBF to the BSS 104.

6. The BSS 104 forwards a page response 114′ with a dummy LLC PDU to the SGSN 106. Note: it is the payload (dummy LLC PDU) of the page response 114 received over the radio interface by the BSS 104 from the MS 102 that the BSS 104 conveys over the Gb interface to the SGSN 106 as the page response 114′. More specifically, the page response 114 sent over the radio interface is mapped to a different message also known as a page response 114 which is sent on the Gb interface. The page responses 114 and 114′ are not identical.

7. The BSS 104 sends a PUAN message 116 (releasing the UL TBF) to the MS 102.

8. The BSS 104 receives DL packets 118 from the SGSN 106.

9. The BSS 104 sends an Immediate Assignment message 120 with a DL TBF assignment to the MS 102.

10. The BSS 104 sends the DL packets 118′ using the assigned DL TBF to the MS 102. The BSS 104 translates the DL packets 118 received from the SGSN 106 on the Gb interface into the DL packets 118′ which has a format appropriate for sending over the radio interface to the MS 102.

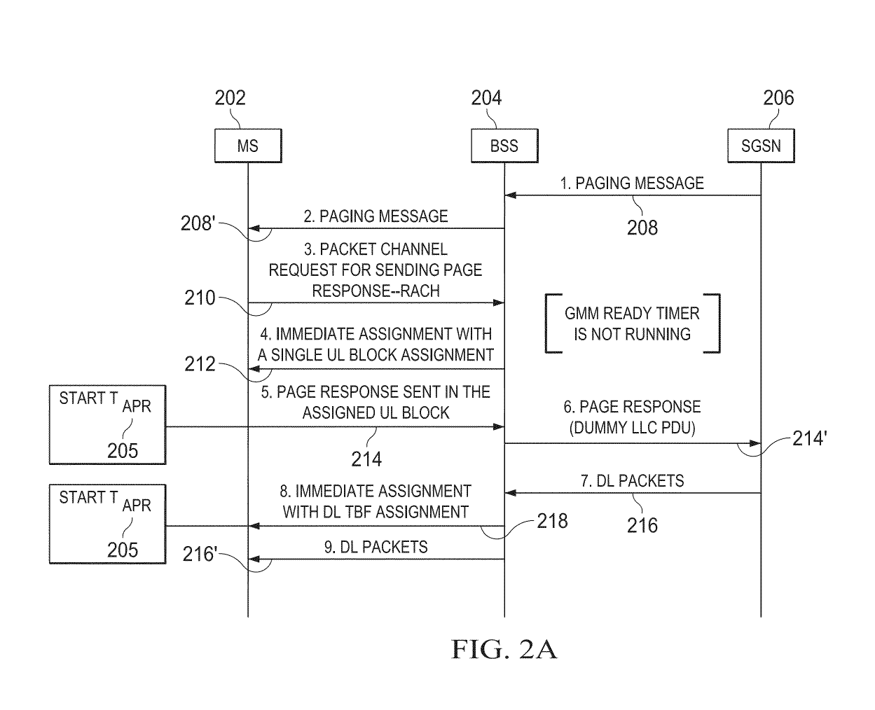

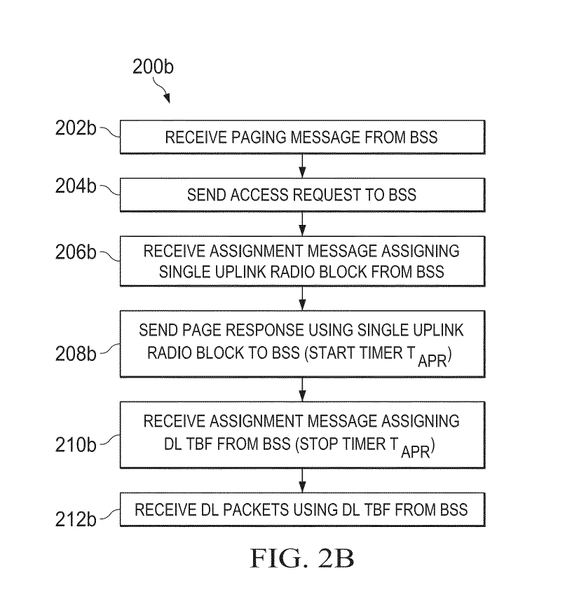

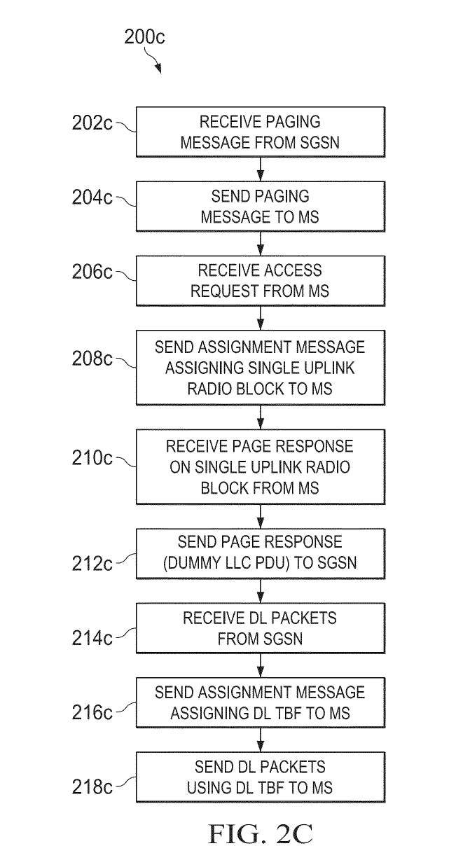

Referring to FIG. 2A, there is a signaling diagram of the APR procedure associated with a UDP/IP scenario in which the delivery of downlink payload to a MS does not trigger a MS response in accordance with a first embodiment of the present disclosure. In this exemplary diagram, the three main components namely a MS 202, an access node 204 (e.g., BSS 204), and a serving node 206 (e.g. SGSN 206) are shown interacting with one another using the new APR procedure to deliver the downlink payload to the MS 202 as follows:

1. The SGSN 206 sends a paging message 208 to the BSS 204.

2. The BSS 204 sends the paging message 208′ to the MS 202. The BSS 204 translates the paging message 208 received from the SGSN 206 on the Gb interface into the paging message 208′ which has a format appropriate for sending over the radio interface to the MS 102.

3. The MS 202 sends a packet channel request 210 (access request 210) to the BSS 204.

4. BSS 204 sends an Immediate Assignment message 212 with a single UL block assignment to the MS 202.

5. The MS 202 sends a page response 214 using the assigned single UL block to the BSS 204. In addition, the MS 202 starts a timer T_{APR} 205 the purpose of which is discussed in more detail below.

6. The BSS 204 forwards a page response 214′ with a dummy LLC PDU to the SGSN 206. Note: it is the payload (dummy LLC PDU) of the page response 214 received over the radio interface by the BSS 204 from the MS 202 that the BSS 204 conveys over the Gb interface to the SGSN 206 as the page response 214′. More specifically, the page response 214 sent over the radio interface is mapped to a different message also known as a page response 214 which is sent on the Gb interface. The page responses 214 and 214′ are not identical.

7. The BSS 204 receives DL packets 216 from the SGSN 206.

8. The BSS 204 sends an Immediate Assignment message 218 with a DL TBF assignment to the MS 202. In addition, the MS 202 stops the timer T_{APR} 205 the purpose of which is discussed in more detail below.

9. The BSS 204 sends the DL packets 216′ using the assigned DL TBF to the MS 202. The BSS 204 translates the DL packets 216 received from the SGSN 206 on the Gb interface into the DL packets 216′ which has a format appropriate for sending over the radio interface to the MS 202.

In this exemplary scenario, the MS 202 is paged for a MS terminated packet service using the legacy principles except that the paging message 208′ which is sent on the PCH could be enhanced to indicate whether or not the APR procedure is to be used (i.e., on a per page basis). If the paging message 208′ is not enhanced to provide the APR indication then the system information sent within an existing or a new System Information message would be needed so that an APR capable MS 202 will know when it can attempt a system access by sending the packet channel request 210 (access request 210) which has an “Abbreviated Page Response” indication therein as shown in TABLE #1 as follows:

TABLE #1
EGPRS Packet Channel Request 210 message content

< EGPRS Packet channel request message content > ::=

| | | |
|---|---|---|
| < One Phase Access Request: | 0 | < MultislotClass : bit (5) > |
| | | < Priority : bit (2) > |
| | | < RandomBits : bit (3) > > |
| \| < Short Access Request: | 100 | — The value 100 was allocated in an |

earlier version of the protocol and shall not be used by the mobile station

| | | < NumberOfBlocks : bit (3) > |
|---|---|---|
| | | < Priority : bit (2) > |
| | | < Random Bits : bit (3) > > |
| \| < One Phase Access Request by Reduced Latency MS: 101 | | < MultislotClassGroup : bit (3) > |
| | | < Priority : bit (2) > |
| | | < RandomBits : bit (3) > > |
| \| < Two Phase Access Request: | 110000 | < Priority : bit (2) > |
| | | < RandomBits : bit (3) > > |
| \| < Signalling: | 110011 | < RandomBits : bit (5) > > |
| \| < One phase Access Request in RLC unack mode: | 110101 | < RandomBits : bit (5) > > |
| \| < Dedicated Channel Request: | 110110 | < RandomBits : bit (5) > > |
| \| < Emergency call: | 110111 | < RandomBits : bit (5) > > |
| \| < Two Phase Access Request by IPA capable MS | 111000 | < Priority : bit (2) > |
| | | < RandomBits : bit (3) > > |
| \| < Signalling by IPA capable MS: | 111001 | < Random Bits : bit (5) > > |
| \| < Abbreviated Page Response: | 111010 | < RandomBits : bit (5) > >; |

Upon receiving, the packet channel request 210, the BSS 204 sends the Immediate Assignment message 212 that matches the packet channel request 210 (e.g., matching means the Immediate Assignment message 212 indicates the TDMA frame number information corresponding to the RACH burst in which the “Abbreviated Page Response” indication was received in the packet channel request 210 at the BSS 204) and indicates the single uplink radio block that the MS 202 is to use to send its page response 214.

After sending the packet channel request 210, the MS 202 receives the matching Immediate Assignment 212 containing the single uplink radio block allocation. For example, the Immediate Assignment 212 may comprise a Packet Channel Description IE, a Timing Advance IE and a Starting Time IE but an IA Rest Octets IE is excluded since an uplink TBF is not needed. The MS 202 responds to the Immediate Assignment 212 by sending the page response 214 in the allocated uplink radio block. The page response 214 is sent using the single uplink radio block and contains a RLC data block which includes (a) the dummy LLC PDU, (b) the TLLI and (c) a new Length Indicator that allows for indicating the inclusion of 1 octet of supplemental information (e.g., see third embodiment for an example when this new Length Indicator would be used to indicate the volume of uplink payload which is available for transmission at the MS) immediately following the new Length Indicator.

After receiving the page response 214, the BSS 204 extracts the TLLI and the dummy LLC PDU and forwards them together as a logical page response 214′ to the SGSN 206 thereby allowing the SGSN 206 to respond by sending the available downlink payload 216 to the serving BSS 204.

Upon completing the transmission of the page response 214, the MS 202 starts a timer T_{APR} 205 and remains in non-DRX mode monitoring the AGCH where it waits for either (a) reception of the Immediate Assignment message 218 (addressed to its TLLI) providing it with a downlink TBF assignment for delivery of the downlink payload 216′, or (b) expiration of the T_{APR} 205. If the MS 202 experiences expiration of the T_{APR} 205 after transmitting the access request 210 (indicating “Abbreviated Page Response”) on the RACH it can return to idle mode or may attempt another system access by sending another packet channel request 210 using the APR procedure depending on how much time has elapsed since it was first paged (received paging message 208′). Information sent as part of system information within an existing or a new System Information message or as part of the paging message 208′ can indicate what the limit is for the maximum amount of time that can elapse since the MS 202 was first paged until the expiration of T_{APR} 205 thereby allowing the MS 202 to determine whether or not to restart the APR procedure by re-sending the packet channel request 210 or return to idle mode (in which case it waits for another paging message). This may be feasible since some SGSN 206 implementations may be quite tolerant of the time between the sending of the packet paging message 208 and the reception of the corresponding page response 214′.

The Immediate Assignment message 218 by containing the TLLI effectively allows the MS 202 to successfully complete contention resolution (i.e., to determine that its page response 214 was captured by the BSS 204). Contention resolution is successfully completed in the BSS 204 upon receiving the page response 214 which includes the TLLI. Hence, a benefit of the APR procedure is that the BSS 204 can set-up a downlink TBF by sending the Immediate Assignment message 218 to enable the delivery of downlink payload 216′ even when there are no USFs available at the time of receiving the page response 214 from the particular MS 202.

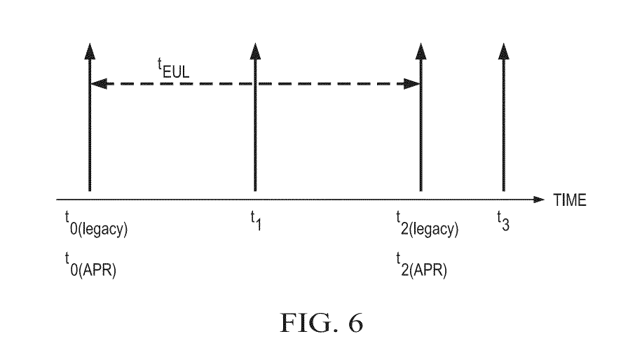

If a real collision occurs where multiple MSs 202 have all sent packet channel requests 210 (access requests 210) including an “Abbreviated Page Response” in the same RACH burst and therefore think they have all been allocated the same single uplink radio block (e.g., the multiple MSs 202 all believe the same received Immediate Assignment 212 matches their respective “Abbreviated Page Response” transmissions) then the MS 202 which is actually captured by the BSS 204 will clearly be able to determine it is the winner of the contention based on the TLLI included in the subsequent Immediate Assignment message 218 which is sent to the MS 202 after its page response 214 has been received by the BSS 204. As discussed above, the MS 202 upon the transmission of the page response 214 will also start the timer T_{APR} 205 at time=t_{0(APR)} (see FIG. 6) however the legacy contention resolution counter (N3104, which counts the number of RLC data blocks transmitted until the PUAN 116 is received as shown in FIG. 1) will not be used since the RLC data block containing the page response 214 is not sent within the context of an uplink TBF.

The advantages of using the APR procedure for delivering downlink payload 216′ in the aforementioned UDP/IP scenario of FIG. 2A when compared to the legacy procedure of FIG. 1 (PRIOR ART) are shown in TABLE #2 where it can be seen that using the APR procedure instead of the legacy procedure requires one less downlink PACCH block transmission (the PUAN message 116) and one less uplink PACCH block transmission (the Packet Control Ack message—not shown in FIG. 1 but is sent by the MS 102 to acknowledge reception of the PUAN message 116) and it improves the availability of USF and TFI resources since the page response 214 is not sent using an UL TBF.

TABLE #2
APR vs Legacy for Delivering Downlink Payload (UDP/IP scenario)

| | | | Legacy Procedure |
|---|---|---|---|
| | | | (Non-extended |
| Signaling Event | | APR Procedure | TBF) |
| 1. | Access Request (RACH) | Y | Y |
| 2. | UL resource assignment | Y (single radio | Y (uplink TBF |
| | (AGCH) | block assigned) | assigned) |
| 3. | Page Response (PDCH) | Y | Y |
| 4. | PUAN with FAI (DL | N/A | Y |
| | PACCH) | | |
| 5. | Packet Control Ack (UL | N/A | Y |
| | PACCH) | | |
| 6. | DL resource assignment | Y (downlink TBF | Y (downlink TBF |
| | (AGCH) | assigned) | assigned) |
| 7. | Downlink RLC data blocks | Y | Y |
| | (PDCH) | | |
| 8. | PDAN with FAI (UL | Y | Y |
| | PACCH) | | |

| | | |
|---|---|---|
| Total PACCH | 1 | 3 |
| Total AGCH | 2 | 2 |

The APR procedure for delivering downlink payload 216′ in the aforementioned UDP/IP scenario of FIG. 2A when compared to the legacy procedure of FIG. 1 (PRIOR ART) also has the following technical features and advantages:
Avoiding the legacy approach of sending a Packet Uplink Ack/Nack 116 to the MS 102 to confirm the BSS 104 reception of the page response 114 is possible in the APR procedure by requiring the MS 202 to wait for a matching Immediate Assignment message 218 which contains the same TLLI as was included in the page response 214 on the AGCH to confirm that the BSS 204 received the page response 214 (step 8 of FIG. 2A).
This means that upon reception of the page response 214 (step 5 of FIG. 2A) the BSS 204 will not attempt to immediately confirm the reception thereof to the MS 202 as per the legacy procedure but will instead just forward the page response 214′ to the SGSN 206 (step 6 of FIG. 2A) and wait until it receives the corresponding downlink payload 216 from the SGSN 206 (step 7 of FIG. 2A).
Upon receiving the downlink payload 216 from the SGSN 206 (step 7 of FIG. 2) the BSS 204 sends the corresponding MS 202 the Immediate Assignment message 218 on the AGCH (step 8 of FIG. 2A) which serves to (a) inform the ME 202 that its page response 214 was received (i.e. contention resolution is completed in the MS 202) and (b) provide the MS 202 with the downlink resources that will be used to send it the downlink payload 216′ (see step 9 of FIG. 2A). In addition, when using the APR procedure the MS 202 starts the timer T_{APR} 205 upon sending the page response 214 (step 5 of FIG. 2A) and stops the timer T_{APR} 205 when it receives the matching Immediate Assignment message 218 (step 8 of FIG. 2A).
Timer T_{APR} 205 may expire as a result of either (a) the BSS 204 failing to receive the page response 214, or (b) the MS 202 failing to receive the Immediate Assignment message 218 assigning the downlink TBF resources. In either case, upon expiration of Timer T_{APR} 205 the MS 202 returns to idle mode or may restart the APR procedure by re-sending the packet channel request 210 (see earlier discussion).
The benefits of using APR for this exemplary scenario are that it: (a) avoids the assignment of an uplink TFI and a USF that would otherwise be needed if an uplink TBF was established to send the page response 214, (b) avoids the transmission of a PUAN 116 and its corresponding Packet Control Ack (see row 5 of TABLE #2), and (c) eliminates the MS power consumption otherwise required for reception of the PUAN 116 and the transmission of its corresponding Packet Control Ack (see row 5 of TABLE #2).

Referring to FIG. 2B, there is a flowchart of a method 200b in the mobile station 202 for implementing the APR procedure in accordance with the first embodiment of the present disclosure. At step 202b, the mobile station 202 receives the paging message 208′ from the BSS 204 (step 2 of FIG. 2A). At step 204b, the mobile station 202 sends the access request 210 to the BSS 204 in response to receiving the paging message 208′ (step 3 in FIG. 2A). At step 206b, the mobile station 202 receives the assignment message 212 from the BSS 204 assigning a single uplink radio block (step 4 of FIG. 2A). At step 208b, the mobile station 202 sends the page response 214 using the single uplink radio block to the BSS 204 (step 5 of FIG. 2A). The page response 214 comprises the TLLI which uniquely identifies the mobile station 202. The mobile station 202 starts the timer T_{APR} 205 upon sending the page response 214. At step 210b, the mobile station 202 receives the assignment message 218 from the BSS 204 assigning the DL TBF (step 8 of FIG. 2A). The assignment message 218 comprises the TLLI to confirm that the BSS 204 received the page response 214. The mobile station 202 stops the timer T_{APR} 205 upon receiving the assignment message 218. In the event, the timer T_{APR} 205 expires as a result of the mobile station 202 not receiving the assignment message 218 in a predetermined amount of time then the mobile station 202 enters an idle mode or restarts the APR procedure by sending another access request 210 to the BSS 204. At step 212b, the mobile station 202 uses the assigned DL TBF to receive the DL packets 216′ from the BSS 204 (step 9 of FIG. 2A).

Referring to FIG. 2C, there is a flowchart of a method 200c in the BSS 204 for implementing the APR procedure in accordance with the first embodiment of the present disclosure. At step 202c, the BSS 204 receives a paging message 208 from the SGSN 206 (step 1 of FIG. 2A). At step 204c, the BSS 204 sends the paging message 208′ to the mobile station 202 (step 2 of FIG. 2A). At step 206c, the BSS 204 receives the access request 210 from the mobile station 202 in response to sending the paging message 208′ (step 3 of FIG. 2A and TABLE #1). At step 208c, the BSS 204 sends the assignment message 212 to the mobile station 202 in response to receiving the access request 210 (step 4 of FIG. 2A). The assignment message 212 indicates a single uplink radio block. At step 210c, the BSS 204 receives the page response 214 on the single uplink radio block from the mobile station 202 (step 5 of FIG. 2A). At step 212c, the BSS 204 sends the page response 214′ (dummy LLC PDU) to the SGSN 206 (step 6 of FIG. 2A). At step 214c, the BSS 204 receives DL packets 216 from the SGSN 206 (step 7 of FIG. 2A). At step 216c, the BSS 204 sends the assignment message 218 to the mobile station 202 assigning the DL TBF (step 8 of FIG. 2A). The assignment message 218 comprises the TLLI to confirm that the BSS 204 received the page response 214. At step 218c, the BSS 204 sends DL packets 216′ based on DL packets 216 using the DL TBF to the mobile station 202 (step 9 of FIG. 2A).

### Second Embodiment: Using the APR Procedure for Delivering Downlink Payload (TCP/IP Scenario)

Referring to FIG. 3 (PRIOR ART), there is a diagram of a legacy signaling procedure (CASE #1) associated with a TCP/IP scenario where the delivery of downlink payload to a MS does trigger a MS response. In this exemplary diagram, the three main components namely a MS 302, an access node 304 (e.g., BSS 304), and a serving node 306 (e.g. SGSN 306) are shown interacting with one another per the legacy procedure (CASE #1) as follows:

1. The SGSN 306 sends a paging message 308 to the BSS 304.

2. The BSS 304 sends the paging message 308′ to the MS 302. The BSS 304 translates the paging message 308 received from the SGSN 306 on the Gb interface into the paging message 308′ which has a format appropriate for sending over the radio interface to the MS 302.

3. The MS 302 sends a packet channel request 310 (access request 310) to the BSS 304.

4. BSS 304 sends an Immediate Assignment message 312 with an extended UL TBF assignment to the MS 302.

5. The MS 302 sends a page response 314 using the assigned extended UL TBF to the BSS 304.

6. The BSS 304 forwards a page response 314′ with a dummy LLC PDU to the SGSN 306. Note: it is the payload (dummy LLC PDU) of the page response 314 received over the radio interface by the BSS 304 from the MS 302 that the BSS 304 conveys over the Gb interface to the SGSN 306 as the page response 314′. More specifically, the page response 314 sent over the radio interface is mapped to a different message also known as a page response 314′ which is sent on the Gb interface. The page responses 314 and 314′ are not identical.

7. The BSS 304 receives DL packets 316 from the SGSN 306.

8. The BSS 304 sends a Packet DL Assignment message 318 on the PACCH to the MS 302.

9. The BSS 304 sends the DL packets 316′ using the assigned DL resources to the MS 302. The BSS 304 translates the DL packets 316 received from the SGSN 306 on the Gb interface into the DL packets 316′ which has a format appropriate for sending over the radio interface to the MS 302.

10. The MS 302 sends a PDAN 320 acknowledging the receipt of the DL packets 316′ (DL PDUs 316) to the BSS 304.

11. The MS 302 has UL packets 322 to send to the BSS 304.

12. The MS 302 sends the UL packets 322 using the assigned extended UL TBF to the BSS 304.

13. The BSS 304 sends the UL packets 322′ to the SGSN 306. The BSS 304 translates the UL packets 322 received from the MS 302 on the radio interface into the UL packets 322′ which has a format appropriate for sending over the Gb interface to the SGSN 306.

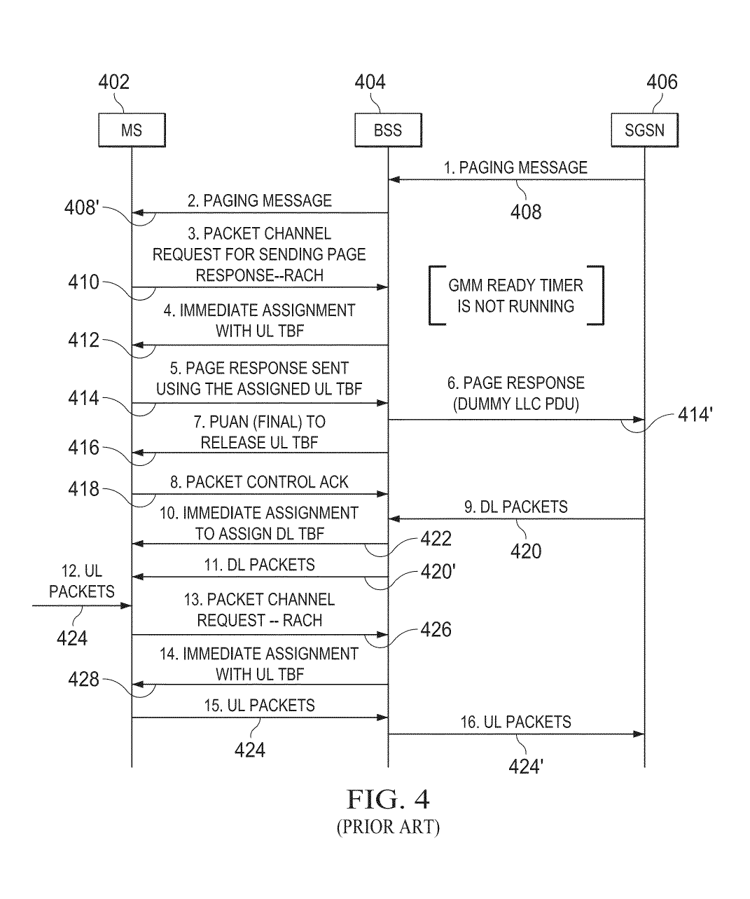

Referring to FIG. 4 (PRIOR ART), there is a diagram of another legacy signaling procedure (CASE #2) associated with a TCP/IP scenario where the delivery of downlink payload to a MS does trigger a MS response. In this exemplary diagram, the three main components namely a MS 402, an access node 404 (e.g., BSS 404), and a serving node 406 (e.g. SGSN 406) are shown interacting with one another per the another legacy procedure (CASE #2) as follows:

1. The SGSN 406 sends a paging message 408 to the BSS 404.

2. The BSS 404 sends the paging message 408′ to the MS 402. The BSS 404 translates the paging message 408 received from the SGSN 406 on the Gb interface into the paging message 408′ which has a format appropriate for sending over the radio interface to the MS 402.

3. The MS 402 sends a packet channel request 410 (access request 410) to the BSS 404.

4. The BSS 404 sends an Immediate Assignment message 412 with an UL TBF assignment to the MS 402.

5. The MS 402 sends a page response 414 using the assigned UL TBF to the BSS 404.

6. The BSS 404 forwards a page response 414′ with a dummy LLC PDU to the SGSN 406. Note: it is the payload (dummy LLC PDU) of the page response 414 received over the radio interface by the BSS 404 from the MS 402 that the BSS 404 conveys over the Gb interface to the SGSN 406 as the page response 414′. More specifically, the page response 414 sent over the radio interface is mapped to a different message also known as a page response 414′ which is sent on the Gb interface. The page responses 414 and 414′ are not identical.

7. The BSS 404 sends a PUAN 416 (final) releasing the UL TBF to the MS 402.

8. The MS 402 sends a packet control acknowledgment 418 to the BSS 404.

9. The BSS 404 receives DL packets 420 from the SGSN 406.

10. The BSS 404 sends an Immediate Assignment message 422 assigning a DL TBF to the MS 402.

11. The BSS 404 sends the DL packets 420′ using the assigned DL TBF to the MS 402. The BSS 404 translates the DL packets 420 received from the SGSN 406 on the Gb interface into the DL packets 420′ which has a format appropriate for sending over the radio interface to the MS 402.

12. The MS 402 has UL packets 424 to send to the BSS 404.

13. The MS 402 sends another packet channel request 426 (access request 426) to the BSS 404.

14. The BSS 404 sends an Immediate Assignment message 428 with an UL TBF assignment to the MS 402.

15. The MS 402 sends the UL packets 424 using the assigned UL TBF to the BSS 404.

16. The BSS 404 sends the UL packets 424′ to the SGSN 406. The BSS 404 translates the UL packets 424 received from the MS 402 on the radio interface into the UL packets 424′ which has a format appropriate for sending over the Gb interface to the SGSN 406.

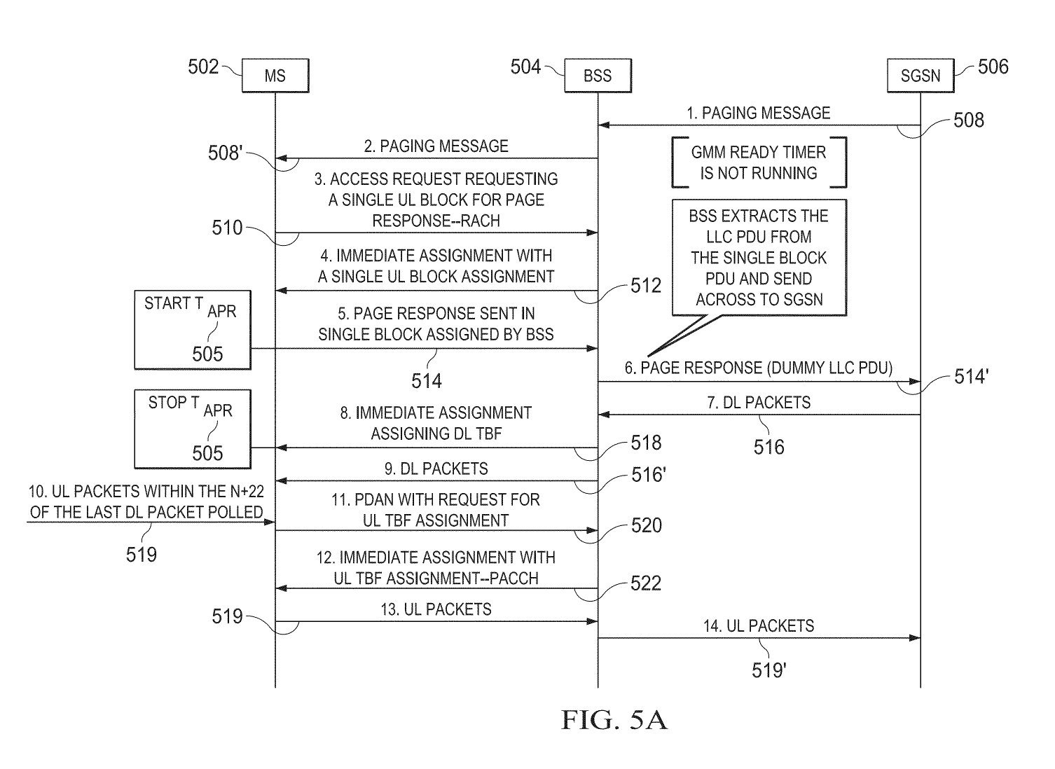

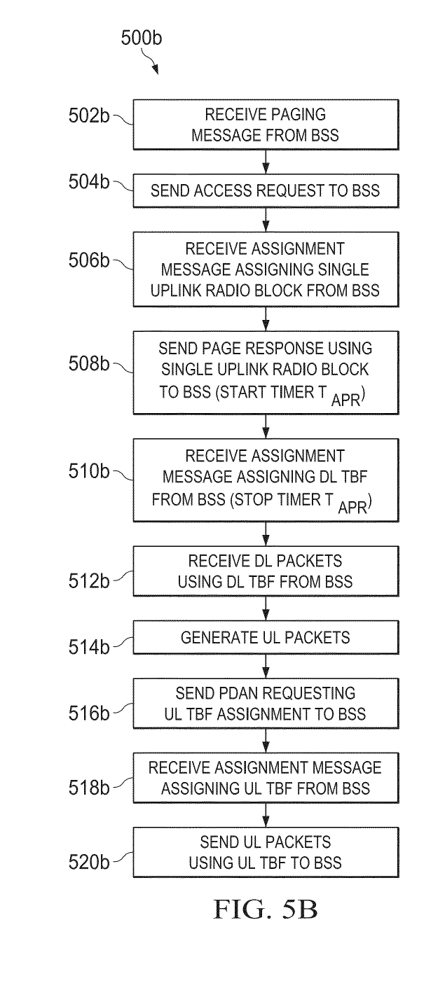

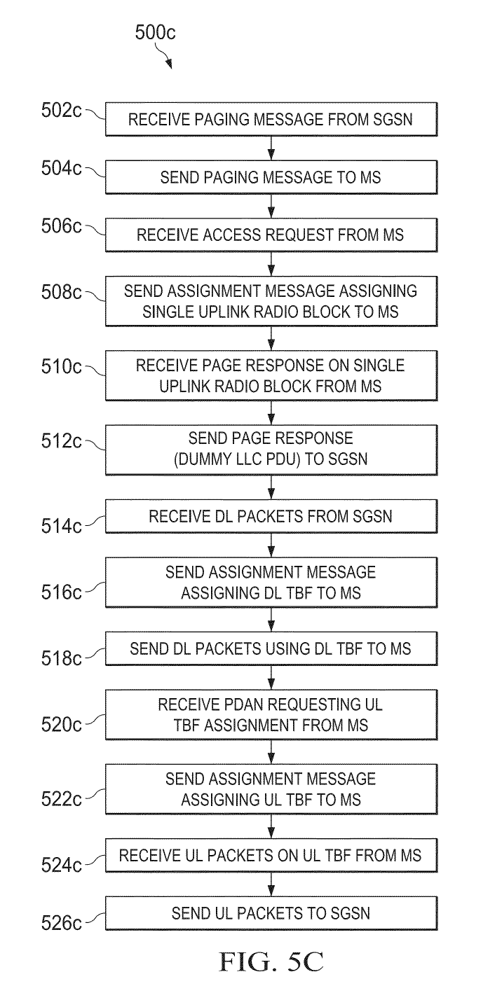

Referring to FIG. 5A, there is a signaling diagram of the APR procedure associated with a TCP/IP scenario where the delivery of downlink payload to a MS does trigger a MS response in accordance with a second embodiment of the present disclosure. In this exemplary diagram, the three main components namely a MS 502, an access node 504 (e.g., BSS 504), and a serving node 506 (e.g. SGSN 506) are shown interacting with one another using the new APR procedure to deliver a downlink payload to the MS 502 which triggers a response from the MS 502 as follows:

1. The SGSN 506 sends a paging message 508 to the BSS 504.

2. The BSS 504 sends the paging message 508′ to the MS 502. The BSS 504 translates the paging message 508 received from the SGSN 506 on the Gb interface into the paging message 508′ which has a format appropriate for sending over the radio interface to the MS 502. In this example, the paging message 508′ which is sent on the PCH indicates that the BSS 504 supports the APR procedure for downlink data delivery. If the paging message 508′ is not enhanced to provide the APR indication then the system information within an existing or a new system information message would be needed so that an APR capable MS 502 will know when it can attempt a system access by sending the packet channel request 510 (access request 510) which has an “Abbreviated Page Response” indication therein as shown in TABLE #1.

3. The MS 502 sends a packet channel request 510 (access request 510) requesting an UL block for a page response to the BSS 504.

4. BSS 504 sends an Immediate Assignment message 512 with a single UL block assignment to the MS 502.

5. The MS 502 sends a page response 514 using the assigned single UL block to the BSS 504. The page response 514 is sent using the single uplink radio block and contains a RLC data block that includes (a) the dummy LLC PDU, (b) the TLLI and (c) a new Length Indicator that allows for indicating the inclusion of 1 octet of supplemental information (e.g., see third embodiment for an example when this new Length Indicator would be used to indicate the volume of uplink payload available for transmission at the MS) immediately following the new Length Indicator. At this time, the MS 502 starts the timer T_{APR} 505—see earlier discussion.

6. The BSS 504 forwards a page response 514′ with a dummy LLC PDU to the SGSN 506. In particular, the BSS 504 extracts the dummy LLC PDU from the single block PDU (paging message 514) and sends the dummy LLC PDU to the SGSN 506. Note: it is the payload (dummy LLC PDU) of the page response 514 received over the radio interface by the BSS 504 from the MS 502 that the BSS 504 conveys over the Gb interface to the SGSN 506 as the page response 514′. More specifically, the page response 514 sent over the radio interface is mapped to a different message also known as a page response 514′ which is sent on the Gb interface. The page responses 514 and 514′ are not identical.

7. The BSS 504 receives DL packets 516 from the SGSN 506.

8. The BSS 504 sends an Immediate Assignment message 518 with a DL TBF assignment to the MS 502. At this time, the MS 502 stops the timer T_{APR} 505—see earlier discussion.

9. The BSS 504 sends the DL packets 516′ using the assigned DL TBF to the MS 502. The BSS 504 translates the DL packets 516 received from the SGSN 506 on the Gb interface into the DL packets 516′ which has a format appropriate for sending over the radio interface to the MS 502.

10. The MS 502 has UL packets 519 to send to the BSS 504. The UL packets 519 requiring transmission are identified shortly after the reception of the last of the DL packets 516′ so that the MS 502 is able to formulate a PDAN 520 that includes a request for an UL TBF assignment by the time the PDAN 520 is to be sent (e.g. the polling request sent in the last of the DL packets 516′ may indicate that the MS 502 is to send a PDAN 520 starting in uplink TDMA frame N+13, N+22 or other possible offsets where N is TDMA frame number of the last TDMA frame used to send the last of the DL packets 516′).

11. The MS 502 sends a PDAN 520 which requests an UL TBF assignment to the BSS 504.

12. The BSS 504 sends an Immediate Assignment message 522 with an UL TBF assignment to the MS 502.

13. The MS 502 sends the UL packets 519 using the assigned UL TBF to the BSS 504.

14. The BSS 504 sends the UL packets 519′ to the SGSN 506. The BSS 504 translates the UL packets 519 received from the MS 502 on the radio interface into the UL packets 519′ which has a format appropriate for sending over the Gb interface to the SGSN 506.

Referring to FIG. 5B, there is a flowchart of a method 500b in the mobile station 502 for implementing the APR procedure in accordance with the second embodiment of the present disclosure. At step 502b, the mobile station 502 receives the paging message 508′ from the BSS 504 (step 2 of FIG. 5A). At step 504b, the mobile station 502 sends the access request 510 to the BSS 504 in response to receiving the paging message 508′ (step 3 of FIG. 5A). At step 506b, the mobile station 502 receives the assignment message 512 from the BSS 504 assigning a single uplink radio block (step 4 of FIG. 5A). At step 508b, the mobile station 502 sends the page response 514 using the single uplink radio block to the BSS 504 (step 5 of FIG. 5A—note the mobile station 502 may also start timer T_{APR} 505 as in the first embodiment). The page response 514 comprises the TLLI which uniquely identifies the mobile station 502. At step 510b, the mobile station 502 receives the assignment message 518 from the BSS 504 assigning the DL TBF (step 8 of FIG. 5A—note the mobile station 502 may also stop timer T_{APR} 505 as in the first embodiment). The assignment message 518 comprises the TLLI to confirm that the BSS 504 received the page response 514. At step 512b, the mobile station 502 uses the assigned DL TBF to receive the DL packets 516′ from the BSS 504 (step 9 of FIG. 5A). At step 514b, the mobile station 502 generates UL packets 519 to send to the BSS 504 (step 10 of FIG. 5A). At step 516b, the mobile station 502 sends the PDAN 520 which requests an UL TBF assignment to the BSS 504 (step 11 of FIG. 5A). At step 518b, the mobile station 502 receives the assignment message 522 with an UL TBF assignment from the BSS 504 (step 12 of FIG. 5A). At step 520b, the mobile station 502 sends the UL packets 519 using the assigned UL TBF to the BSS 504 (step 13 of FIG. 5A).

Referring to FIG. 5C, there is a flowchart of a method 500c in the BSS 504 for implementing the APR procedure in accordance with the second embodiment of the present disclosure. At step 502c, the BSS 504 receives a paging message 508 from the SGSN 506 (step 1 of FIG. 5A). At step 504c, the BSS 504 sends the paging message 508′ to the mobile station 502 (step 2 of FIG. 5A). At step 506c, the BSS 504 receives the access request 510 from the mobile station 502 in response to sending the paging message 508′ (step 3 of FIG. 5A and TABLE #1). At step 508c, the BSS 504 sends the assignment message 512 to the mobile station 502 in response to receiving the access request 510 (step 4 of FIG. 5A). The assignment message 512 indicates a single uplink radio block. At step 510c, the BSS 504 receives the page response 514 on the single uplink radio block from the mobile station 502 (step 5 of FIG. 5A). At step 512c, the BSS 504 sends the page response 514′ (dummy LLC PDU) to the SGSN 506 (step 6 of FIG. 5A). At step 514c, the BSS 504 receives DL packets 516 from the SGSN 506 (step 7 of FIG. 5A). At step 516c, the BSS 504 sends the assignment message 518 to the mobile station 502 assigning the DL TBF (step 8 of FIG. 5A). The assignment message 518 comprises the TLLI to confirm that the BSS 504 received the page response 514. At step 518c, the BSS 504 sends the DL packets 516′ based on DL packets 516 using the DL TBF to the mobile station 502 (see step 9 of FIG. 5A). At step 520c, the BSS 504 receives the PDAN 520 which requests an UL TBF assignment from the mobile station 502 (step 11 of FIG. 5A). At step 522c, the BSS 504 sends the assignment message 522 with an UL TBF assignment to the mobile station 502 (step 12 of FIG. 5A). At step 524c, the BSS 504 receives the UL packets 519 on the assigned UL TBF from the mobile station 502 (step 13 of FIG. 5A). At step 526c, the BSS 504 sends the UL packets 519′ based on UL packets 519 to the SGSN 506 (step 14 of FIG. 5A).

FIGS. 3-4 (PRIOR ART) show two different legacy signaling procedures associated with the TCP/IP scenario (i.e. delivery of downlink payload that triggers a MS response) and FIGS. 5A-5C show how this same scenario is supported using the APR procedure in accordance with a second embodiment of the present disclosure. The advantages of using the APR procedure for this TCP/IP scenario are similar to using the APR procedure in the UDP/IP scenario described above with respect to FIGS. 1-2 in addition to the following:
The use of the APR procedure allows the MS 502 to request an uplink TBF establishment when sending the PDAN 520 which is also used to confirm the reception of all the DL payload 516′ (see signal 11 of FIG. 5A). It is expected that the MS 502 will be able to process the complete DL payload 516′ in time to use the PDAN 520 to request establishment of the uplink TBF required to send the TCP level response at time t=t_{2(APR)} as shown in FIG. 6.
It should be noted that generally every 1 or 2 downlink TCP/IP packets 516′ are acknowledged by the MS 502 at the TCP layer. Considering that the RLC entity in BSS 504 sends the last downlink TDMA frame containing the TCP/IP packet 516′ in TDMA frame N, the CES/P or the ES/P field within the corresponding RLC data block indicates the required MS response time (e.g. the CES/P field in this RLC data block indicates the MS 502 is polled and it shall therefore send a PDAN 520 starting in uplink TDMA frame N+13, N+22 or other possible offsets).
However, the processing delay in the MS 502 in handling the downlink TCP/IP packets 516′ and responding back with the TCP Ack may take more time than is allowed by the CES/P field. To allow for this possibility, the APR procedure for downlink payload delivery could implicitly indicate that the poll response time provided by the CES/P field or ES/P field is to be doubled (e.g. if CES/P indicates a poll response time of 13 then the MS 502 shall consider the actual poll response time to be 26). Another mechanism for extending the poll response time would be to define the CES/P field and ES/P field to have values unique to a downlink TBF established using the APR procedure.

In addition, the advantages of using the APR procedure for the TCP/IP scenario when compared to the legacy signaling procedure (CASE #1) shown in FIG. 3 (PRIOR ART) are as follows:
The use of the APR procedure related to CASE #1 is addressed in FIG. 5A which shows the MS 502 only requesting establishment of an uplink TBF when it knows it actually needs one (i.e. the PDAN 520 sent in step 11 includes a request for an uplink TBF). This can be contrasted to using the legacy procedure shown in FIG. 3 (PRIOR ART) where the uplink TBF established at step 4 is maintained using an extended uplink TBF mode because it is anticipated that the MS 302 will eventually need to send a TCP level response as a result of processing the downlink payload 316.
Using the extended uplink TBF mode as per the legacy operation means that during time interval t_{EUL} (see FIG. 6) the USF+TFI remain assigned but unused and as such there is a corresponding reduction in the efficiency with which these UL TBF resources are managed (e.g., the probability of uplink TBF blocking is increased).
The net gain of using the APR procedure for this case of the TCP/IP scenario compared to the legacy procedure includes: (a) saving a downlink PACCH block transmission at the expense of one more AGCH transmission (e.g., for the APR procedure the BSS 504 sends the DL TBF resource assignment using the AGCH whereas for legacy the BSS 304 sends the DL TBF resource assignment using the DL PACCH of the UL TBF used to send the page response), and (b) improving the availability of USF and TFI resources (see TABLE #3). Given the ability to increase AGCH capacity if needed (e.g. using IPA), reducing PACCH signaling by requiring an additional AGCH message is considered as having a positive effect on PDCH utilization.

TABLE #3
APR vs Legacy for Delivering Downlink Payload (TCP/IP scenario - case #1)

| | | | Legacy Procedure (with |
|---|---|---|---|
| Signaling Event | | APR Procedure | extended UL TBF) |
| 1. | Access Request (RACH) | Y | Y |
| 2. | UL resource assignment (AGCH) | Y (single radio block | Y (uplink TBF assigned) |
| | | assigned) | |
| 3. | Page Response (PDCH) | Y | Y |
| 4. | PUAN (DL PACCH) | N/A | Y |
| 5. | DL resource assignment (AGCH) | Y (downlink TBF assigned) | N/A |
| 6. | DL resource Assignment (DL | N/A | Y (downlink TBF |
| | PACCH) | | assigned) |
| 7. | Downlink RLC data blocks | Y | Y |
| | (PDCH) | | |
| 8. | PDAN with FAI (UL PACCH) | Y (with UL TBF request) | Y |
| 9. | Packet Uplink Assign.(DL | Y (uplink TBF assigned) | N/A |
| | PACCH) | | |
| 10. | Uplink RLC data blocks (PDCH) | Y | Y |
| 11. | PUAN with FAI (DL PACCH) | Y | Y |
| 12. | Packet Control Ack (UL | Y | Y |
| | PACCH) | | |

| | | |
|---|---|---|
| Total PACCH | 4 | 5 |
| Total AGCH | 2 | 1 |

The advantage of using the APR procedure for this particular scenario are also shown in TABLE #3 where it can be seen that using the APR procedure instead of the legacy procedure requires one less downlink PACCH block transmission and improves the availability of USF and TFI resources for uplink TBFs since they will not be assigned until they are actually needed as per step 9 of TABLE #3 (signal 11 of FIG. 5A). However, when using the legacy procedure with the extended uplink TBF mode, the USF and TFI are assigned in step 2 and used in step 3 of TABLE #3 (signals 3 and 4 of FIG. 3 (PRIOR ART)) but are not used again until step 10 of TABLE #3 (signal 12 of FIG. 3 (PRIOR ART)) and as such the legacy procedure represents a reduced efficiency in the management of these radio resources (see t_{EUL} in FIG. 6).

Moreover, the advantages of using the APR procedure for the TCP/IP scenario when compared to the legacy signaling procedure (CASE #2) shown in FIG. 4 (PRIOR ART) are as follows:
The use of the APR procedure related to CASE #2 is also addressed in FIG. 5A which shows the MS 502 only requesting establishment of an uplink TBF when it knows it actually needs one (i.e. the PDAN 520 sent in step 11 includes a request for an uplink TBF). This can be contrasted to using the legacy procedure shown in FIG. 4 (PRIOR ART) wherein the uplink TBF established at step 4 is released in steps 7 and 8 (i.e., extended uplink TBF mode is not used).
The legacy procedure of FIG. 4 (PRIOR ART) involves the assignment of USF and TFI resources for the UL TBF used to send the page response 414 will not be as efficient as the APR procedure of FIG. 5A from a USF and TFI management point of view because since the legacy procedure requires that the USF and TFI resources remain allocated starting from when the uplink TBF established at step 4 of FIG. 4 and ending when that uplink TBF is released in step 7 of FIG. 4. Furthermore, the legacy procedure of FIG. 4 (PRIOR ART) requires additional signaling including: (a) a PUAN with a Final Ack Indicator set to ‘1’ sent on the downlink PACCH to confirm reception of the page response/trigger (step 7); and (b) a PACKET CONTROL ACKNOWLEDGEMENT message sent on the uplink PACCH to confirm MS reception of the PUAN (step 8).
The net gain of using the APR procedure for this case of the TCP/IP scenario compared to legacy procedure includes: (a) saving a downlink PACCH block transmission, (b) saving an uplink PACCH block transmission, and (c) improving the availability of USF and TFI resources. These advantages are indicated in TABLE #4.

TABLE #4
APR vs Legacy for Delivering Downlink Payload (TCP/IP scenario - case #2)

| | | | Legacy Procedure |
|---|---|---|---|
| | | | (without extended UL |
| Signaling Event | | APR Procedure | TBF) |
| 1. | Access Request (RACH) | Y | Y |
| 2. | UL resource assignment | Y (single radio block | Y (uplink TBF assigned) |
| | (AGCH) | assigned) | |
| 3. | Page Response (PDCH) | | Y |
| 4. | PUAN with FAI (DL PACCH) | N/A | Y |
| 5. | Packet Control Ack (UL | N/A | Y |
| | PACCH) | | |
| 6. | DL resource assignment | Y (downlink TBF assigned) | Y (downlink TBF |
| | (AGCH) | | assigned) |
| 7. | Downlink RLC data blocks | Y | Y |
| | (PDCH) | | |
| 8. | PDAN with FAI (UL PACCH) | Y (UL TBF request) | Y (UL TBF Request) |
| 9. | Packet Uplink Assign.(DL | Y (UL TBF assigned) | Y (UL TBF assigned) |
| | PACCH) | | |
| 10. | Uplink RLC data blocks | Y | Y |
| | (PDCH) | | |
| 11. | PUAN with FAI (DL PACCH) | Y | Y |
| 12. | Packet Control Ack (UL | Y | Y |
| | PACCH) | | |

| | | |
|---|---|---|
| Total PACCH | 4 | 6 |
| Total AGCH | 2 | 2 |

Referring to FIG. 6, there is a diagram illustrating the timing associated with the use of UL TBF resources with regards to the legacy procedures of FIGS. 1 and 3-4 (PRIOR ART) and the APR procedure of FIGS. 2A-2C and 5A-5C. The timing information is as follows:

t_{0(legacy)}—The MS 102 and 402 receives PUAN 116 and 416 confirming reception of page response 114 and 414 sent using an uplink TBF, the BSS 104 and 404 forwards the page response 114′ and 414′ to SGSN 106 and 406.

t_{0(APR)}—The APR capable MS 202 and 502 sends the single uplink radio block containing the page response 214 and 514 to the BSS 204 and 504. The BSS 204 and 504 forwards the page response 214′ and 514′ to the SGSN 206 and 506.

t₁—The BSS 104, 204, 304, 404 and 504 receives downlink payload 118, 216, 316, 420 and 516 from the SGSN 106, 206, 306, 406 and 506 and sends the Immediate Assignment message 120, 218, 318, 422 and 518 to the MS 102, 202, 302, 402 and 502. Once, the downlink TBF is established, the BSS 104, 204, 304, 404 and 504 begins delivery of downlink payload 118′, 216′, 316′, 420′ and 516′ to the MS 102, 202, 302, 402 and 502.

t_{2(legacy)}—The MS 302 sends the PDAN 320 confirming reception of all downlink payload 316′ and transmission of uplink payload 322 can start (use of the extended uplink TBF can be resumed). Note: in practice there can be a delay in starting the uplink payload 322 transmission since the BSS 304 will take some time before it schedules the next USF for the already established uplink TBF (e.g., this could easily be 20 ms or more).

t_{2(APR)}—The APR capable MS 502 sends the PDAN 520 confirming reception of all downlink payload 516′ and requesting the establishment of an uplink TBF.

t₃—The APR capable MS 502 receives Packet Uplink Assignment 522 (providing USF+TFI assignments) and then transmission of the uplink payload 519 can start. Note: this represents a delay in starting the uplink payload transmission (e.g. 40 ms) compared to the legacy case but this delay could easily be the same as the delay associated with the legacy case (see t_{2(legacy)} above).

t_{EUL}=the time that MS 302 spends in extended uplink TBF mode with a USF and TFI assigned but not used.

Referring to FIG. 7A, there is a signaling diagram of the APR procedure associated with a MS triggering scenario in accordance with a third embodiment of the present disclosure. In this exemplary diagram, the three main components namely a MS 702, an access node 704 (e.g., BSS 704), and a serving node 706 (e.g. SGSN 706) are shown interacting with one another using the new APR procedure associated with a MS triggering scenario as follows:

1. The SGSN 706 sends a paging message 708 (for triggering the MS 702 to send data) to the BSS 704.

2. The BSS 704 sends the paging message 708′ (for triggering the MS 702 to send data) to the MS 702. The BSS 704 translates the paging message 708 received from the SGSN 706 on the Gb interface into the paging message 708′ which has a format appropriate for sending over the radio interface to the MS 702. In this example, the paging message 708′ indicates that the BSS 704 not only supports the APR procedure for trigger delivery but indicates that the MS 702 is to send data for the SGSN 706—compare to the paging message 508′ in FIG. 5A (second embodiment) which just indicates that the BSS 504 supports the APR procedure.

3. The MS 702 sends a packet channel request 710 (access request 710) requesting an UL block for a page response to the BSS 704 (see TABLE #1—the MS 702 indicates it is APR capable by using the “Abbreviated Page Response” code point).

4. BSS 704 sends an Immediate Assignment message 712 with a single UL block assignment to the MS 702.

5. The MS 702 sends a page response 714 using the assigned single UL block to the BSS 704. The page response 714 has an indication indicating that there are “X” pending UL blocks. In one example, the page response 714 is sent using the single uplink radio block and contains a RLC data block that includes (a) the dummy LLC PDU, (b) the TLLI and (c) a new Length Indicator that allows for indicating the inclusion of 1 octet of supplemental information (e.g., the volume of uplink payload available for transmission at the MS 702) immediately following the new Length Indicator. The inclusion of this new Length Indicator serves to inform the BSS 704 that the MS 702 has uplink payload (“X” pending UL blocks) to send and therefore an uplink TBF needs to be assigned (i.e., the uplink TBF is needed regardless if the page response 714′, when relayed to the SGSN 706, results in the SGSN 706 sending the BSS 704 downlink packets (downlink payload) to be delivered to the MS 702). At this time, the MS 702 starts the timer T_{APR} 505—see earlier discussion.

6. The BSS 704 forwards a page response 714′ with a dummy LLC PDU to the SGSN 706. In particular, the BSS 704 extracts the LLC PDU from the single block PDU and sends the dummy LLC PDU to the SGSN 706. Note: it is the payload (dummy LLC PDU) of the page response 714 received over the radio interface by the BSS 704 from the MS 702 that the BSS 704 conveys over the Gb interface to the SGSN 706 as the page response 714′. More specifically, the page response 714 sent over the radio interface is mapped to a different message also known as a page response 714′ which is sent on the Gb interface. The page responses 714 and 714′ are not identical.

7. The BSS 704 sends an Immediate Assignment message 716 with an UL TBF assignment for only “X” blocks (similar to the Short Access Request feature used for uplink TBF established as defined in 3GPP TS 44.060 V4.10.0—the contents of which are incorporated herein by reference or an open ended legacy type UL TBF) to the MS 702. At this time, the MS 502 stops the timer T_{APR} 505—see earlier discussion.

8. The MS 702 sends the UL blocks 718 using the assigned “X” blocks of the UL TBF to the BSS 704.

9. The BSS 704 sends the UL blocks 718′ to the SGSN 706. The BSS 704 translates the UL blocks 718 received from the MS 702 on the radio interface into the UL blocks 718′ which has a format appropriate for sending over the Gb interface to the SGSN 706.

In the third embodiment, the paging message 708′ sent on the PCH is able to indicate a specific “trigger condition”. In this example, the paging message 708′ sent on the PCH indicates everything the MS 702 needs in order to determine exactly what uplink payload 718 (uplink blocks 718) needs to be sent in response to that “trigger condition”. The following is a more detailed explanation of the aforementioned steps 1-9:
The MS 702 responds to the paging message 708′ by sending the access request 710 indicating Abbreviated Page Response (see TABLE #1) and it receives a matching Immediate Assignment message 712 granting it a single uplink radio block.
The page response 714 sent by the MS 702 using the single uplink radio block can indicate the transmission of X radio blocks is pending (see discussion below about the page response 714). The MS 702 starts timer T_{APR} 705 upon sending the page response 714 and stops T_{APR} 705 when it receives a matching Immediate Assignment message 716 on the AGCH (steps 5 and 7 of FIG. 7A).
The BSS 704 forwards the page response 714′ to the SGSN 706 thereby confirming that a page indicating a specific “trigger condition” has been delivered to the target MS 702 (step 6 of FIG. 7A). In this example, the SGSN 706 does not respond by sending downlink payload to the BSS 704 since there is no downlink payload to send.
The BSS 704 sends the MS 702 the Immediate Assignment message 716 confirming reception of the page response 714 and allocating the MS 702 resources for an uplink TBF so that the transmission of RLC data blocks 718 by the MS 702 thereon can begin (steps 7 and 8 of FIG. 7A). Note: the BSS 704 realizes it needs to assign an uplink TBF because the page response 714 indicated that an uplink payload was pending.

Referring to FIG. 7B, there is a flowchart of a method 700b in the mobile station 702 for implementing the APR procedure in accordance with the third embodiment of the present disclosure. At step 702b, the mobile station 702 receives the paging message 708′ from the BSS 704 (step 2 of FIG. 7A). The paging message 708′ has a trigger condition indicating that the mobile station 702 needs to send uplink payload in response to the trigger condition. At step 704b, the mobile station 702 sends the access request 710 to the BSS 704 in response to receiving the paging message 708′ (step 3 in FIG. 7A). At step 706b, the mobile station 702 receives the assignment message 712 from the BSS 704 assigning a single uplink radio block (step 4 of FIG. 7A). At step 708b, the mobile station 702 sends the page response 714 using the single uplink radio block to the BSS 704 (step 5 of FIG. 7A—note the mobile station 502 starts timer T_{APR} 705 as in the first embodiment). The page response 514 comprises the TLLI which uniquely identifies the mobile station 702 and further indicates a transmission of a certain number “X” of uplink blocks 718 is pending. At step 710b, the mobile station 702 receives the assignment message 716 from the BSS 704 assigning an UL TBF for only “X” blocks (similar to the Short Access Request feature used for uplink TBF established as defined in 3GPP TS 44.060 V4.10.0 or an open ended legacy type UL TBF) to the mobile station 702 (step 7 of FIG. 7A—note the mobile station 502 stops timer T_{APR} 705 as in the first embodiment). The assignment message 716 also comprises the TLLI to confirm that the BSS 704 received the page response 714. At step 712b, the mobile station 502 uses the assigned UL TBF to send the “X” uplink blocks 718 to the BSS 704 (step 8 of FIG. 7A).

Referring to FIG. 7C, there is a flowchart of a method 700c in the BSS 704 for implementing the APR procedure in accordance with the third embodiment of the present disclosure. At step 702c, the BSS 704 receives a paging message 708 from the SGSN 706 (step 1 of FIG. 7A). The paging message 708 has a trigger condition indicating that the mobile station 702 needs to send uplink payload in response to the trigger condition. At step 704c, the BSS 704 sends the paging message 708′ to the mobile station 702 (step 2 of FIG. 7A). At step 706c, the BSS 704 receives the access request 710 from the mobile station 702 in response to sending the paging message 708′ (step 3 of FIG. 7A and TABLE #1). At step 708c, the BSS 504 sends the assignment message 712 to the mobile station 702 in response to receiving the access request 710 (step 4 of FIG. 7A). The assignment message 712 indicates a single uplink radio block. At step 710c, the BSS 704 receives the page response 714 on the single uplink radio block from the mobile station 702 (step 5 of FIG. 7A). The page response 714 comprises the TLLI which uniquely identifies the mobile station 702 and further indicates a transmission of a certain number “X” of uplink blocks 718 is pending. At step 712c, the BSS 704 sends the page response 714′ (dummy LLC PDU) to the SGSN 706 (step 6 of FIG. 7A). At step 714c, the BSS 704 sends the assignment message 716 to the mobile station 702 assigning an UL TBF for only “X” blocks (similar to the Short Access Request feature used for uplink TBF established as defined in 3GPP TS 44.060 V4.10.0 or an open ended legacy type UL TBF) to the mobile station 702 (step 7 of FIG. 7A). The assignment message 716 also comprises the TLLI to confirm that the BSS 704 received the page response 714. At step 716c, the BSS 704 receives the “X” uplink blocks 718 from the mobile station (step 8 of FIG. 7A). At step 718c, the BSS 704 sends the “X” uplink blocks 718′ based on “X” uplink blocks 718 to the SGSN 706 (step 9 of FIG. 7A).

Referring to FIG. 7D, there is a flowchart of a method 700d in the SGSN 706 for implementing the APR procedure in accordance with the third embodiment of the present disclosure. At step 702d the SGSN 706 sends the paging message 708 to the BSS 706 (step 1 of FIG. 7A). The paging message 708 comprises trigger information which indicates to the mobile station 702 that uplink payload is to be sent to the SGSN 706. More specifically, the paging message 708′ which is sent on the PCH indicates everything the mobile station 702 needs in order to determine exactly what uplink payload 718 (uplink blocks 718) needs to be sent in response to that “trigger condition”. At step 704d, the SGSN 706 receives from the BSS 704 the page response 714′ that includes a dummy LLC PDU extracted by the BSS 704 from the page response 714 sent by the MS 702 (step 6 of FIG. 7A). At step 706d, the SGSN 706 receives from the BSS 704 the “X” uplink blocks 718′ provided by the mobile station 702 in response to the paging message 708′ (step 9 of FIG. 7A).

The advantages of using the APR procedure in the aforementioned MS triggering scenario when compared to the legacy procedure where the uplink TBF used to send the page response is retained using the extended uplink TBF mode (see FIG. 3 (PRIOR ART)) is shown in TABLE #5 and consists of saving a downlink PACCH block transmission used for assigning an UL TBF at the expense of one more AGCH transmissions used for assigning an UL TBF. Given the ability to increase AGCH capacity if needed (e.g., using IPA), reducing PACCH signaling (one less downlink PACCH block transmission) by requiring an additional AGCH message is considered as having a positive effect on PDCH utilization. Alternatively, given the minimal addition to RACH/AGCH load imposed by the introduction of MSs such as MTC devices it will be beneficial to use the available RACH/AGCH bandwidth/capacity for sending access request/assignment messages instead of using the limited PDTCH resources for sending PACCH messages.

TABLE #5
APR for Device Triggering

| | | | Legacy Procedure (with |
|---|---|---|---|
| Signaling Event | | APR Procedure | extended UL TBF) |
| 1. | Access Request (RACH) | Y | Y |
| 2. | UL resource assignment (AGCH) | Y (single radio block | Y (uplink TBF assigned) |
| | | assigned) | |
| 3. | Page Response (PDCH) | Y (UL TBF request) | Y |
| 4. | PUAN (DL PACCH) | N/A | Y |
| 5. | DL resource assignment (AGCH) | N/A | N/A |
| 6. | DL resource Assignment (DL | N/A | Y (downlink TBF |
| | PACCH) | | assigned) |
| 7. | Downlink RLC data blocks | N/A | Y |
| | (PDCH) | | |
| 8. | PDAN with FAI (UL PACCH) | N/A | Y |
| 9. | UL resource assignment (AGCH) | Y (uplink TBF assigned) | N/A |
| 10. | Uplink RLC data blocks (PDCH) | Y | Y |
| 11. | PUAN with FAI (DL PACCH) | Y | Y |
| 12. | Packet Control Ack (UL | Y | Y |
| | PACCH) | | |

| | | |
|---|---|---|
| Total PACCH | 2 | 5 |
| Total AGCH | 2 | 1 |

Note: The advantage of using the APR procedure in the third embodiment instead of the legacy procedures is that the new procedure requires two less downlink PACCH block transmissions and one less uplink PACCH block transmission.

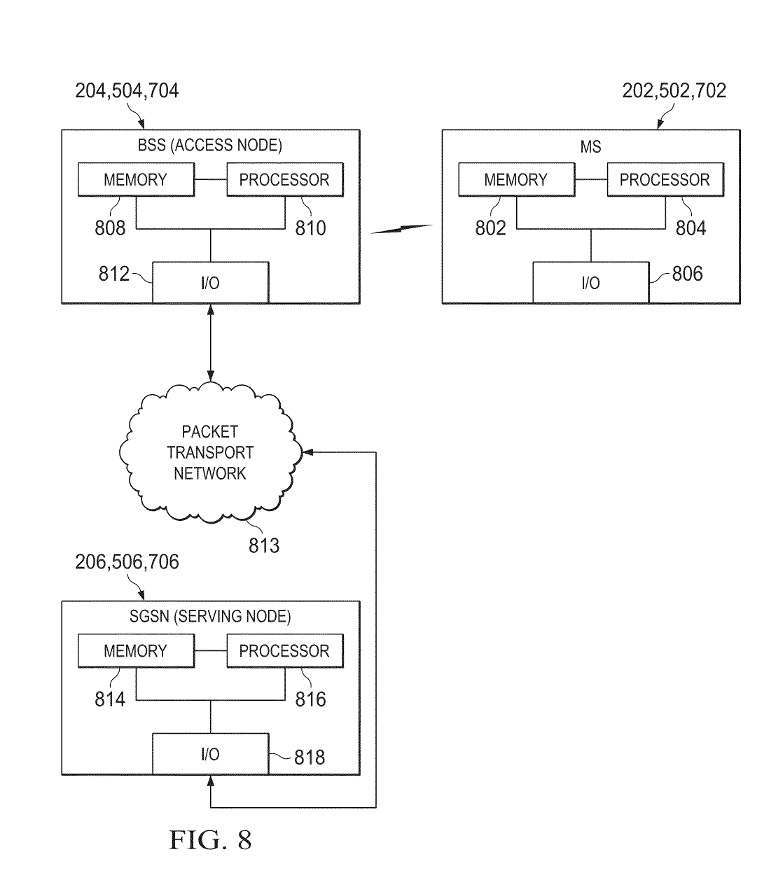

Referring to FIG. 8, there is a schematic view of a mobile station 202, 502 and 702, an access node 204, 504 and 704 (e.g., BSS 204, 504 and 704), and a serving node 206, 506 and 706 (e.g., SGSN 206, 506 and 706) which are configured to implement the APR procedure and various methods 200b, 200c, 500b, 500c, 700b, 700c and 700d in accordance with different embodiments of the present disclosure. The mobile station 202, 502 and 702 comprises a memory 802, a processor 804 for executing instructions stored in the memory 802 and an input/output device 806 for communication with other nodes and devices. The mobile station 202, 502 and 702 is in radio connection with the access node 204, 504 and 704 (e.g., BSS 204, 504 and 704) which comprises a memory 808, a processor 810 suitable for executing instructions stored in the memory 808 as well as an input/output device 812 connected to a packet transport network 813. The serving node 206, 506 and 706 (e.g., SGSN 206, 506 and 706) comprises a memory 814, a processor 816 suitable for executing instructions stored in the memory 814 as well as an input/output device 818 which is also connected to the packet transport network 813. In any case, the present arrangement of the mobile station 202, 502 and 702, the access node 204, 504 and 704 (e.g., BSS 204, 504 and 704), and the serving node 206, 506 and 706 (e.g., SGSN 206, 506 and 706) are suitable for executing the various methods 200b, 200c, 500b, 500c, 700b, 700c and 700d disclosed herein with respect to FIGS. 2A-2C, 5A-5C and 7A-7D.

It should be noted that the mobile station 202, 502 and 702, the access node 204, 504 and 704 (e.g., BSS 204, 504 and 704), and the serving node 206, 506 and 706 (e.g., SGSN 206, 506 and 706) each comprise many other components which are well known in the art but for clarity the well known components are not described herein. Moreover, it should be noted that a typical network would comprise multiple mobile stations 202, 502 and 702, multiple access nodes 204, 504 and 704 (e.g., BSSs 204, 504 and 704) as well as a plethora of other network nodes which may or may not be in the path of packets sent between the mobile station 202, 502, 702 and the serving node 206, 506 and 706 (e.g., SGSN 206, 506 and 706).

Further, it should be noted that there are many different types of memories 802, 808 and 814 available, such as solid states drives, hard drives, RAM, ROM, EPROM, EEPROM etc. which could be used in implementing embodiments disclosed herein. The memory 802 used for the mobile station 202, 502 and 702 would typically be different from the memory 814 used for the serving node 206, 506 and 706 (e.g., SGSN 206, 506 and 706), however there is absolutely nothing preventing them for utilizing the same kind of memory. Also, while not indicated in the schematic view, there might be multiple different memories in the devices disclosed. Typically, there would be persistent storage as well as Random Access Memory. Also the processors 804, 810 and 816 indicated in the schematic view can be implemented in many different forms, such as an off-the-shelf microcontroller, an ASIC, FPGA etc.

In view of the foregoing, it should be appreciated that the APR procedure results in reducing the amount of PACCH signaling by at least 20% when compared to legacy procedures for the case of small data transmissions downlink as described herein. In some cases, the APR procedure realizes a reduction in PACCH signaling at the expense of a corresponding increase in AGCH signaling but this is still considered as a net gain given the options that exist for increasing the AGCH capacity if needed (e.g. IPA). As such, the APR procedure is seen as being useful towards realizing the EMDA goal of improving PDCH utilization and to support the APR procedure the following specification (standard) changes should be made within the GERAN Rel-13 time frame:
Modify paging messages (e.g. using a Rel-13 extension to the P1/P2/P3 Rest Octets IE) to indicate a mobile station that supports the APR procedure shall respond to the paging message by sending an access request indicating “Abbreviated Page Response” (see, TS 44.018 V12.1.0—the contents of which are incorporated herein by reference).
Mandate that a BSS assign a single uplink radio block in response to receiving an access request indicating “Abbreviated Page Response” (TS 44.018 V12.1.0).
Define a new code point for the EGPRS Packet Channel Request message called “Abbreviated Page Response” (TS 44.060 V11.7.0—the contents of which are incorporated herein by reference).
Modify Packet Downlink Ack/Nack (PDAN) messages to include information for informing a BSS of the volume of information to be transferred for the UL TBF being requested by the PDAN (TS 44.060 V11.7.0).
Introduce (a) a new Length Indicator for inclusion within a RLC data block and used for informing a BSS that a MS is requesting an uplink TBF and (b) a 1 octet field immediately following the new Length Indicator used to indicate the volume of information to be transferred using that UL TBF (TS 44.060 V11.7.0).

Although multiple embodiments of the present disclosure have been illustrated in the accompanying Drawings and described in the foregoing Detailed Description, it should be understood that the invention is not limited to the disclosed embodiments, but instead is also capable of numerous rearrangements, modifications and substitutions without departing from the present disclosure that as has been set forth and defined within the following claims.

1. A mobile station configured to implement an abbreviated page response (APR) procedure with an access node, the mobile station comprising:
a processor; and,
at least one memory that stores processor-executable instructions, wherein the processor interfaces with the at least one memory to execute the processor-executable instructions, whereby said mobile station is operable to:
receive, from the access node, a paging message;
send, to the access node, an access request in response to receiving the paging message;
receive, from the access node, an assignment message assigning a single uplink radio block; and,
send, to the access node, a page response using the single uplink radio block.

2. The mobile station of claim 1, wherein the mobile station is further operable to:
receive, from the access node, another assignment message assigning a downlink Temporary Block Flow (TBF) after the page response has been sent;
receive, from the access node, downlink packets using the downlink TBF;
send, to the access node, a Packet Downlink Ack/Nack (PDAN) message which confirms reception of the downlink packets and requests establishment of an uplink TBF;
receive, from the access node, yet another assignment message assigning the uplink TBF; and,
send, to the access node, uplink packets using the uplink TBF.

3. The mobile station of claim 2, wherein:
the page response comprises a Temporary Logical Link Identifier (TLLI) which uniquely identifies the mobile station; and,
the another assignment message comprises the TLLI to confirm that the access node received the page response.

4. The mobile station of claim 2, wherein the mobile station is further operable to:
start a timer upon sending the page response; and
stop the timer upon receiving the another assignment message, wherein if the timer expires as a result of not receiving the another assignment message in a predetermined amount of time then the mobile station is further operable to enter an idle mode or restart the APR procedure by sending another access request to the access node.

5. The mobile station of claim 1, wherein:
the paging message has a trigger condition indicating that the mobile station needs to send uplink payload in response to the trigger condition;
the page response further indicates a transmission of a certain number of uplink blocks is pending;
the mobile station is further operable to:
receive, from the access node, another assignment message assigning an uplink TBF for the certain number of uplink blocks; and,
send, to the access node, the certain number of uplink blocks using the uplink TBF.

6. The mobile station of claim 1, wherein:
the paging message indicates that the access node supports the APR procedure; and,
the access request comprises an Enhanced General Packet Radio Service (EGPRS) Packet Channel Request Code Point indicating the mobile station supports the APR procedure.

7. The mobile station of claim 1, wherein the access node is a Base Station Subsystem (BSS).

8. A method in a mobile station for implementing an abbreviated page response (APR) procedure with an access node, the method comprising:
receiving, from the access node, a paging message;
sending, to the access node, an access request in response to receiving the paging message;
receiving, from the access node, an assignment message assigning a single uplink radio block; and,
sending, to the access node, a page response using the single uplink radio block.

9. The method of claim 8, further comprising:
receiving, from the access node, another assignment message assigning a downlink Temporary Block Flow (TBF) after sending the page response;
receiving, from the access node, downlink packets using the downlink TBF;
sending, to the access node, a Packet Downlink Ack/Nack (PDAN) message which confirms reception of the downlink packets and requests establishment of an uplink TBF;
receiving, from the access node, yet another assignment message assigning the uplink TBF; and,
sending, to the access node, uplink packets using the uplink TBF.

10. The method of claim 9, wherein:
the page response comprises a Temporary Logical Link Identifier (TLLI) which uniquely identifies the mobile station; and,
the another assignment message comprises the TLLI to confirm that the access node received the page response.

11. The method of claim 9, further comprising:
starting a timer upon sending the page response; and
stopping the timer upon receiving the another assignment message, wherein if the timer expires as a result of not receiving the another assignment message in a predetermined amount of time then the mobile station is further operable to enter an idle mode or restart the APR procedure by sending another access request to the access node.

12. The method of claim 8, wherein:
the paging message has a trigger condition indicating that the mobile station needs to send uplink payload in response to the trigger condition;
the page response further indicates a transmission of a certain number of uplink blocks is pending;
the method further comprising:
receiving, from the access node, another assignment message assigning an uplink TBF for the certain number of uplink blocks; and,
sending, to the access node, the certain number of uplink blocks using the uplink TBF.

13. The method of claim 8, wherein:
the paging message indicates that the access node supports the APR procedure; and,
the access request comprises an Enhanced General Packet Radio Service (EGPRS) Packet Channel Request Code Point indicating the mobile station supports the APR procedure.

14. The method of claim 8, wherein the access node is a Base Station Subsystem (BSS).

15. An access node configured to implement an abbreviated page response (APR) procedure with a mobile station and a serving node, the access node comprising:
a processor; and,
at least one memory that stores processor-executable instructions, wherein the one processor interfaces with the at least one memory to execute the processor-executable instructions, whereby said access node is operable to:
receive, from the serving node, a paging message;
send, to the mobile station, a paging message based on the received paging message;
receive, from the mobile station, an access request in response to sending the paging message;
send, to the mobile station, an assignment message in response to receiving the access request, wherein the assignment message indicates a single uplink radio block; and,
receive, from the mobile station, a page response on the single uplink radio block.

16. The access node of claim 15, wherein the access node is further operable to:
send, to the serving node, a page response that includes a dummy Logical Link Control (LLC) Protocol Data Unit (PDU) which was extracted from the received page response;
receive, from the serving node, downlink packets in response to sending the page response;
send, to the mobile station, another assignment message assigning a downlink Temporary Block Flow (TBF);
send, to the mobile station, downlink packets based on the received downlink packets using the downlink TBF;
receive, from the mobile station, a Packet Downlink Ack/Nack (PDAN) message which confirms reception of the downlink packets and requests establishment of an uplink TBF;
send, to the mobile station, yet another assignment message assigning the uplink TBF;
receive, from the mobile station, uplink packets using the uplink TBF; and,
send, to the serving node, uplink packets based on the received uplink packets.

17. The access node of claim 15, wherein:
the page response comprises a Temporary Logical Link Identifier (TLLI) which uniquely identifies the mobile station; and,
the another assignment message comprises the TLLI to confirm reception by the access node of the page response.

18. The access node of claim 15, wherein:
the paging message has a trigger condition indicating that the mobile station needs to send uplink payload in response to the trigger condition;
the page response indicates a transmission of a certain number of uplink blocks is pending;
the access node is further operable to:
send, to the serving node, a page response that includes a dummy Logical Link Control (LLC) Protocol Data Unit (PDU) extracted from the received page response;
send, to the mobile station, another assignment message assigning an uplink TBF for the certain number of uplink blocks;
receive, from the mobile station, the certain number of uplink blocks using the uplink TBF; and,
send, to the serving node, uplink blocks based on the received uplink blocks.

19. The access node of claim 15, wherein:
the paging message indicates that the access node supports the APR procedure; and,
the access request comprises an Enhanced General Packet Radio Service (EGPRS) Packet Channel Request Code Point indicating the mobile station supports the APR procedure.

20. The access node of claim 15, wherein the access node is a Base Station Subsystem (BSS) and the serving node is a Serving GPRS Support Node (SGSN).

21. A method in an access node for implementing an abbreviated page response (APR) procedure with a mobile station and a serving node, the method comprising:
receiving, from the serving node, a paging message;
sending, to the mobile station, a paging message based on the received paging message;
receiving, from the mobile station, an access request in response to sending the paging message;
sending, to the mobile station, an assignment message in response to receiving the access request, wherein the assignment message indicates a single uplink radio block; and,
receiving, from the mobile station, a page response on the single uplink radio block.

22. The method of claim 21, further comprising:
sending, to the serving node, a page response that includes a dummy Logical Link Control (LLC) Protocol Data Unit (PDU) which was extracted from the received page response;
receiving, from the serving node, downlink packets in response to sending the page response;
sending, to the mobile station, another assignment message assigning a downlink Temporary Block Flow (TBF);
sending, to the mobile station, downlink packets based on the received downlink packets using the downlink TBF;
receiving, from the mobile station, a Packet Downlink Ack/Nack (PDAN) message which confirms reception of the downlink packets and requests establishment of an uplink TBF;
sending, to the mobile station, yet another assignment message assigning the uplink TBF;
receiving, from the mobile station, uplink packets using the uplink TBF; and,
sending, to the serving node, uplink packets based on the received uplink packets.

23. The method of claim 21, wherein:
the page response comprises a Temporary Logical Link Identifier (TLLI) which uniquely identifies the mobile station; and,
the another assignment message comprises the TLLI to confirm reception by the access node of the page response.

24. The method of claim 21, wherein:
the paging message has a trigger condition indicating that the mobile station needs to send uplink payload in response to the trigger condition;
the page response indicates a transmission of a certain number of uplink blocks is pending;
the method further comprising:
send, to the serving node, a page response that includes a dummy Logical Link Control (LLC) Protocol Data Unit (PDU) extracted from the received page response;
send, to the mobile station, another assignment message assigning an uplink TBF for the certain number of uplink blocks;
receive, from the mobile station, the certain number of uplink blocks using the uplink TBF; and,
send, to the serving node, uplink blocks based on the received uplink blocks.

25. The method of claim 21, wherein:
the paging message indicates that the access node supports the APR procedure; and,
the access request comprises an Enhanced General Packet Radio Service (EGPRS) Packet Channel Request Code Point indicating the mobile station supports the APR procedure.

26. The method of claim 21, wherein the access node is a Base Station Subsystem (BSS) and the serving node is a Serving GPRS Support Node (SGSN).

27. A serving node configured to implement an abbreviated page response (APR) procedure with a mobile station (MS) and an access node, the serving node comprising:
a processor; and,
at least one memory that stores processor-executable instructions, wherein the processor interfaces with the at least one memory to execute the processor-executable instructions, whereby said serving node is operable to:
send, to the access node, a paging message comprising trigger information which indicates to the MS that uplink payload is to be sent to the serving node;
receive, from the access node, a page response; and
receive, from the access node, uplink blocks provided by the MS in response to the paging message.

28. The serving node of claim 27, wherein the access node is a Base Station Subsystem (BSS) and the serving node is a Serving GPRS Support Node (SGSN).

29. A method in a serving node for implementing an abbreviated page response (APR) procedure with a mobile station (MS) and an access node, the method comprising:
sending, to the access node, a paging message comprising trigger information which indicates to the MS that uplink payload is to be sent to the serving node;
receiving, from the access node, a page response; and
receiving, from the access node, uplink blocks provided by the MS in response to the paging message.

30. The method of claim 29, wherein the access node is a Base Station Subsystem (BSS) and the serving node is a Serving GPRS Support Node (SGSN).
